(19) United States
(12) Patent Application Publication
(10) Pub. No.: US 2022/0214524 A1
(43) Pub. Date: Jul. 7, 2022

(54) Camera Lens Assembly

(71) Applicant: ZHEJIANG SUNNY OPTICS CO.,LTD., Ningbo (CN)

(72) Inventors: Yi ZHANG, Ningbo (CN); Fujian DAI, Ningbo (CN); Liefeng ZHAO, Ningbo (CN)

(21) Appl. No.: 17/558,619

(22) Filed: Dec. 22, 2021

(30) Foreign Application Priority Data
Jan. 4, 2021 (CN) 202110004523.3

(51) Int. Cl. G02B 13/00; G02B 9/64

(52) U.S. Cl. CPC G02B 13/0045; G02B 9/64

(57) ABSTRACT

The disclosure provides a camera lens assembly, which sequentially including from an object side to an image side along an optical axis: a first lens with a positive refractive power; a second lens with a negative refractive power; a third lens; a fourth lens; a fifth lens; a sixth lens; a seventh lens with a negative refractive power; wherein an on-axis distance TTL from an object-side surface of the first lens to an imaging surface of the camera lens assembly, a half of a diagonal length ImgH of an effective pixel region on the imaging surface and an effective focal length f of the camera lens assembly satisfy: 6 mm<TTL*(ImgH/f)<7 mm; a center thickness CT4 of the fourth lens, a center thickness CT5 of the fifth lens and an air space T56 from the fifth lens to the sixth lens on the optical axis satisfy: 0.5<(CT4+CT5)/T56≤1.3.

### CROSS-REFERENCE TO RELATED PRESENT INVENTION(S)

The disclosure claims priority to and the benefit of Chinese Patent Present invention No. 202110004523.3, filed in the China National Intellectual Property Administration (CNIPA) on 4 Jan. 2021, which is incorporated herein by reference in its entirety.

### TECHNICAL FIELD

The disclosure relates to the technical field of optical imaging device, and in particular to a camera lens assembly.

### BACKGROUND

With popularization of electronic products, such as mobile phones, tablets etc. people's demand for portability and thinness of electronic products is getting higher and higher. At the same time, with the performance improvement and size reduction of charge-coupled device (CCD) and complementary metal-oxide semiconductor (CMOS) image sensors, the corresponding imaging lens also need to satisfy the requirements of high imaging quality.

That is, there is a problem that miniaturization and high imaging quality of the imaging lens are difficult to achieve at the same time in the related art.

### SUMMARY

Some embodiments of the disclosure provide a camera lens assembly to solve the problem that miniaturization and high imaging quality of the imaging lens is difficult to achieve at the same time in the related art.

In order to achieve the foregoing purpose, an embodiment of the disclosure provides a camera lens assembly, which sequentially including from an object side to an image side along an optical axis: a first lens with a positive refractive power; a second lens with a negative refractive power; a third lens; a fourth lens; a fifth lens, an object-side surface thereof is a convex surface; a sixth lens; and a seventh lens with a negative refractive power; wherein, TTL is an on-axis distance from an object-side surface of the first lens to an imaging surface of the camera lens assembly, ImgH is a half of a diagonal length of an effective pixel region on the imaging surface, TTL, ImgH and an effective focal length f of the camera lens assembly satisfy: 6 mm<TTL*(ImgH/f)<7 mm; a center thickness CT4 of the fourth lens, a center thickness CT5 of the fifth lens and an air space T56 from the fifth lens to the sixth lens on the optical axis satisfy: 0.5<(CT4+CT5)/T56≤1.3.

In an implementation mode, the effective focal length f of the camera lens assembly and a maximum half field of view HFOV of the camera lens assembly satisfy: f*tan(HFOV)≥5.4 mm.

In an implementation mode, an air space T23 from a second lens to a third lens on the optical axis, an air space T34 from the third lens to the fourth lens on the optical axis and an air space T45 from the fourth lens to the fifth lens on the optical axis satisfy: 1.9≤(T23+T45)/T34<4.0.

In an implementation mode, the effective focal length f of the camera lens assembly and a curvature radius R9 of the object-side surface of the fifth lens satisfy: 0<f/R9≤2.0.

In an implementation mode, the effective focal length f of the camera lens assembly, a center thickness CT6 of the sixth lens, a center thickness CT7 of the seventh lens and an air space T67 from the sixth lens to the seventh lens on the optical axis satisfy: 3≤f/(CT6+T67+CT7)<4.5.

In an implementation mode, a curvature radius R1 of an object-side surface of the first lens, a curvature radius R2 of an image-side surface of the first lens and a center thickness CT1 of the first lens satisfy: 3.5<|R1−R2|/CT1<8.5.

In an implementation mode, a maximum effective radius DT11 of an object-side surface of the first lens, a maximum effective radius DT61 of an object-side surface of the sixth lens and a maximum effective radius DT72 of an image-side surface of the seventh lens satisfy: 0.3<2*DT11/(DT61+DT72)<0.5.

In an implementation mode, SAG11 is an on-axis distance from an intersection point of an object-side surface of the first lens and the optical axis to a maximum effective radius of the object-side surface of the first lens, SAG11, a center thickness CT1 of the first lens and an edge thickness ET1 of the first lens at the maximum effective radius satisfy: 1.5≤ET1/(CT1−SAG11)≤2.0.

In an implementation mode, a combined focal length f67 of the sixth lens and the seventh lens, a curvature radius R11 of an object-side surface of the sixth lens and a curvature radius R14 of an image-side surface of the seventh lens satisfy: −2.5≤f67/(R11+R14)<−0.5.

In an implementation mode, SAG22 is an on-axis distance from an intersection point of an image-side surface of the second lens and the optical axis to a maximum effective radius of the image-side surface of the second lens, SAG22 and an edge thickness ET2 of the second lens at the maximum effective radius satisfy: 0.8<SAG22/ET2≤1.3.

In an implementation mode, the effective focal length f of the camera lens assembly, an effective focal length f3 of the third lens and an effective focal length f4 of the fourth lens satisfy: |f/f3+f/f4|<0.2.

In an implementation mode, the effective focal length f of the camera lens assembly and an effective focal length f5 of the fifth lens satisfy: −0.1<f/f5<0.5.

In an implementation mode, an effective focal length f1 of the first lens, an effective focal length f2 of the second lens and an effective focal length f7 of the seventh lens satisfy: −4.5≤(f2+f7)/f1<−3.0.

In an implementation mode, a center thickness CT2 of the second lens, a center thickness CT3 of the third lens, the center thickness CT4 of the fourth lens and the center thickness CT5 of the fifth lens satisfy: 0.3 mm≤(CT2+CT3+CT4+CT5)/4≤0.35 mm.

Another embodiment of the disclosure provides a camera lens assembly, which sequentially including from an object side to an image side along an optical axis: a first lens with a positive refractive power; a second lens with a negative refractive power; a third lens; a fourth lens; a fifth lens, an object-side surface thereof is a convex surface; a sixth lens; and a seventh lens with a negative refractive power; wherein a maximum effective radius DT11 of an object-side surface of the first lens, a maximum effective radius DT61 of an object-side surface of the sixth lens and a maximum effective radius DT72 of an image-side surface of the seventh lens satisfy: 0.3<2*DT11/(DT61+DT72)<0.5; TTL is an on-axis distance from an object-side surface of the first lens to an imaging surface of the camera lens assembly, ImgH is a half of a diagonal length of an effective pixel region on the imaging surface, TTL, ImgH and an effective focal length f of the camera lens assembly satisfy: 6 mm<TTL*(ImgH/f)<7 mm.

In an implementation mode, the effective focal length f of the camera lens assembly and a maximum half field of view HFOV of the camera lens assembly satisfy: f*tan(HFOV)≥5.4 mm.

In an implementation mode, an air space T23 from the second lens to the third lens on the optical axis, an air space T34 from the third lens to the fourth lens on the optical axis and an air space T45 from the fourth lens to the fifth lens on the optical axis satisfy: 1.9≤(T23+T45)/T34<4.0.

In an implementation mode, the effective focal length f of the camera lens assembly and a curvature radius R9 of the object-side surface of the fifth lens satisfy: 0<f/R9≤2.0.

In an implementation mode, the effective focal length f of the camera lens assembly, a center thickness CT6 of the sixth lens, a center thickness CT7 of the seventh lens and an air space T67 from the sixth lens to the seventh lens on the optical axis satisfy: 3≤f/(CT6+T67+CT7)<4.5.

In an implementation mode, a curvature radius R1 of an object-side surface of the first lens, a curvature radius R2 of an image-side surface of the first lens and a center thickness CT1 of the first lens satisfy: 3.5<|R1−R2|/CT1<8.5.

In an implementation mode, SAG11 is an on-axis distance from an intersection point of an object-side surface of the first lens and the optical axis to a maximum effective radius of the object-side surface of the first lens, SAG11, a center thickness CT1 of the first lens and an edge thickness ET1 of the first lens at the maximum effective radius satisfy: 1.5≤ET1/(CT1−SAG11)≤2.0.

In an implementation mode, a combined focal length f67 of the sixth lens and the seventh lens, a curvature radius R11 of an object-side surface of the sixth lens and a curvature radius R14 of an image-side surface of the seventh lens satisfy: −2.5≤f67/(R11+R14)<−0.5.

In an implementation mode, SAG22 is an on-axis distance from an intersection point of an image-side surface of the second lens and the optical axis to a maximum effective radius of the image-side surface of the second lens, SAG22 and an edge thickness ET2 of the second lens at the maximum effective radius satisfy: 0.8<SAG22/ET2≤1.3.

In an implementation mode, the effective focal length f of the camera lens assembly, an effective focal length f3 of the third lens and an effective focal length f4 of the fourth lens satisfy: |f/f3+f/f4|<0.2.

In an implementation mode, the effective focal length f of the camera lens assembly and an effective focal length f5 of the fifth lens satisfy: −0.1<f/f5<0.5.

In an implementation mode, an effective focal length f1 of the first lens, an effective focal length f2 of the second lens and an effective focal length f7 of the seventh lens satisfy: −4.5≤(f2+f7)/f1<−3.0.

In an implementation mode, a center thickness CT2 of the second lens, a center thickness CT3 of the third lens, a center thickness CT4 of the fourth lens and a center thickness CT5 of the fifth lens satisfy: 0.3 mm≤(CT2+CT3+CT4+CT5)/4≤0.35 mm.

Applying the technical solution of the disclosure, sequentially including from an object side to an image side along an optical axis: a first lens, a second lens, a third lens, a fourth lens, a fifth lens, a sixth lens, and a seventh lens, the first lens has a positive refractive power; the second lens has a negative refractive power; an object-side surface of the fifth lens is a convex surface; and a seventh lens has a negative refractive power; wherein TTL is an on-axis distance from an object-side surface of the first lens to an imaging surface of the camera lens assembly, ImgH is a half of a diagonal length of an effective pixel region on the imaging surface, TTL, ImgH and an effective focal length f of the camera lens assembly satisfy: 6 mm<TTL*(ImgH/f)<7 mm; a center thickness CT4 of the fourth lens, a center thickness CT5 of the fifth lens and an air space T56 from the fifth lens to the sixth lens on the optical axis satisfy: 0.5<(CT4+CT5)/T56≤1.3.

By reasonable arrangement of refractive power, an astigmatism and a distortion may be effectively reduced, and an imaging quality of the camera lens assembly may be greatly improved. By reasonably controlling the on-axis distance TTL from the object-side surface of the first lens to an imaging surface of the camera lens assembly, the half of the diagonal length ImgH of the effective pixel region on the imaging surface and the effective focal length f of the camera lens assembly, characteristics of large image surface and ultra-thinness for the camera lens assembly may be ensured. By reasonably controlling a ratio of the center thickness CT4 of the fourth lens to the center thickness CT5 of the fifth lens and an air space T56 from the fifth lens to the sixth lens on the optical axis, a distortion of the system may be reasonably controlled, so that the system has good distortion performance, high image quality of the system and the imaging quality of the camera lens assembly may be ensured.

### BRIEF DESCRIPTION OF THE DRAWINGS

The accompanying drawings in the description, which form a part of the disclosure, are used to provide a further understanding of the disclosure. Exemplary embodiments of the disclosure and their descriptions are used to explain the disclosure, and do not unduly limit the disclosure. In the drawings:

FIG. 1 shows a structural schematic diagram of a camera lens assembly according to Example 1 of the disclosure;

FIGS. 2-5 show a longitudinal aberration curve, an astigmatism curve, a distortion curve and a lateral color curve of the camera lens assembly in FIG. 1 respectively;

FIG. 6 shows a structural schematic diagram of a camera lens assembly according to Example 2 of the disclosure;

FIGS. 7-10 show a longitudinal aberration curve, an astigmatism curve, a distortion curve and a lateral color curve of the camera lens assembly in FIG. 6 respectively;

FIG. 11 shows a structural schematic diagram of a camera lens assembly according to Example 3 of the disclosure;

FIGS. 12-15 show a longitudinal aberration curve, an astigmatism curve, a distortion curve and a lateral color curve of the camera lens assembly in FIG. 11 respectively;

FIG. 16 shows a structural schematic diagram of a camera lens assembly according to Example 4 of the disclosure;

FIGS. 17-20 show a longitudinal aberration curve, an astigmatism curve, a distortion curve and a lateral color curve of the camera lens assembly in FIG. 16 respectively;

FIG. 21 shows a structural schematic diagram of a camera lens assembly according to Example 5 of the disclosure;

FIGS. 22-25 show a longitudinal aberration curve, an astigmatism curve, a distortion curve and a lateral color curve of the camera lens assembly in FIG. 21 respectively;

FIG. 26 shows a structural schematic diagram of a camera lens assembly according to Example 6 of the disclosure;

FIGS. 27-30 show a longitudinal aberration curve, an astigmatism curve, a distortion curve and a lateral color curve of the camera lens assembly in FIG. 26 respectively;

FIG. 31 shows a structural schematic diagram of a camera lens assembly according to Example 7 of the disclosure;

FIGS. 32-35 show a longitudinal aberration curve, an astigmatism curve, a distortion curve and a lateral color curve of the camera lens assembly in FIG. 31 respectively;

FIG. 36 shows a structural schematic diagram of a camera lens assembly according to Example 8 of the disclosure;

FIGS. 37-40 show a longitudinal aberration curve, an astigmatism curve, a distortion curve and a lateral color curve of the camera lens assembly in FIG. 36 respectively;

FIG. 41 shows a structural schematic diagram of a camera lens assembly according to Example 9 of the disclosure;

FIGS. 42-45 show a longitudinal aberration curve, an astigmatism curve, a distortion curve and a lateral color curve of the camera lens assembly in FIG. 41 respectively;

FIG. 46 shows a structural schematic diagram of a camera lens assembly according to Example 10 of the disclosure;

FIGS. 47-50 show a longitudinal aberration curve, an astigmatism curve, a distortion curve and a lateral color curve of the camera lens assembly in FIG. 46 respectively;

FIG. 51 shows a structural schematic diagram of a camera lens assembly according to Example 11 of the disclosure;

FIGS. 52-55 show a longitudinal aberration curve, an astigmatism curve, a distortion curve and a lateral color curve of the camera lens assembly in FIG. 51 respectively.

Wherein the above drawings include the following reference numerals:

STO, a diaphragm; E1, a first lens; S1, an object-side surface of the first lens; S2, an image-side surface of the first lens; E2, a second lens; S3, an object-side surface of the second lens; S4, an image-side surface of the second lens; E3, a third lens; S5, an object-side surface of the third lens; S6, an image-side surface of the third lens; E4, a fourth lens; S7, an object-side surface of the fourth lens; S8, an image-side surface of the fourth lens; E5, a fifth lens; S9, an object-side surface of the fifth lens; S10, an image-side surface of the fifth lens; E6, a sixth lens; S11, an object-side surface of the sixth lens; S12, an image-side surface of the sixth lens; E7, a seventh lens; S13, an object-side surface of the seventh lens; S14, an image-side surface of the seventh lens; E8, an optical filter; S15, an object-side surface of the optical filter; S16, an image-side surface of the optical filter; S17, an imaging surface.

### DETAILED DESCRIPTION OF THE EMBODIMENTS

It should be noted that the embodiments of the disclosure and the features in the embodiments may be combined with each other without conflict. The disclosure is described in detail below with reference to the drawings and in combination with embodiments.

It should be pointed out that unless otherwise specified, all technical and scientific terms used in the disclosure have the same meanings as commonly understood by those skilled in the art to which the disclosure belongs.

In the disclosure, the directional words such as “up, down, top, bottom” are usually used for the direction shown in the drawings, or for the component itself in the vertical, perpendicular or gravity direction. Similarly, for the convenience of understanding and description, “inside and outside” refers to inside and outside with respect to the contour of each component itself, but the above locative words are not used to limit the disclosure.

It should be noted that in this description, the statements of first, second, third, etc. are only used to distinguish one feature from another, and do not indicate any limitation on the feature. Therefore, the first lens discussed below may also be called the second lens or the third lens without departing from the teaching of the disclosure.

In the drawings, the thickness, size and shape of the lens have been slightly exaggerated for convenience of explanation. In particular, the shapes of spherical or aspheric surface shown in the drawings are shown by way of example. That is, the shape of the spherical or aspheric surface is not limited to the shape of the spherical or aspheric surface shown in the drawings. The drawings are only examples and are not strictly drawn to scale.

Herein, near axis region refers to the region near the optical axis. If a surface of a lens is a convex surface and the position of the convex surface is not defined, it means that the surface of the lens is convex surface at least in the near axis region; If a surface of a lens is a concave surface and the position of the concave surface is not defined, it means that the surface of the lens is concave surface at least in the near axis region. A surface of each lens near the object-side surface becomes the object-side surface of the lens, and the surface of each lens near the image-side surface is called the image-side surface of the lens. The judgment of the surface shape in the near axis region may be based on the judgment mode of a person of ordinary skill in this art, and the convexity and concavity may be judged by the positive or negative value of R (R refers to a curvature radius of near axis region, usually refers to the R value in lens database in optical software). From the object-side surface, when the R value is positive, it is judged as convex surface, and when the R value is negative, it is judged as concave surface; From the image-side surface, when the R value is positive, it is judged as concave surface, and when the R value is negative, it is judged as convex surface.

In order to solve the problem that miniaturization and high imaging quality of imaging lenses are difficult to achieve at the same time in the related art, the disclosure provides a camera lens assembly.

### Embodiment 1

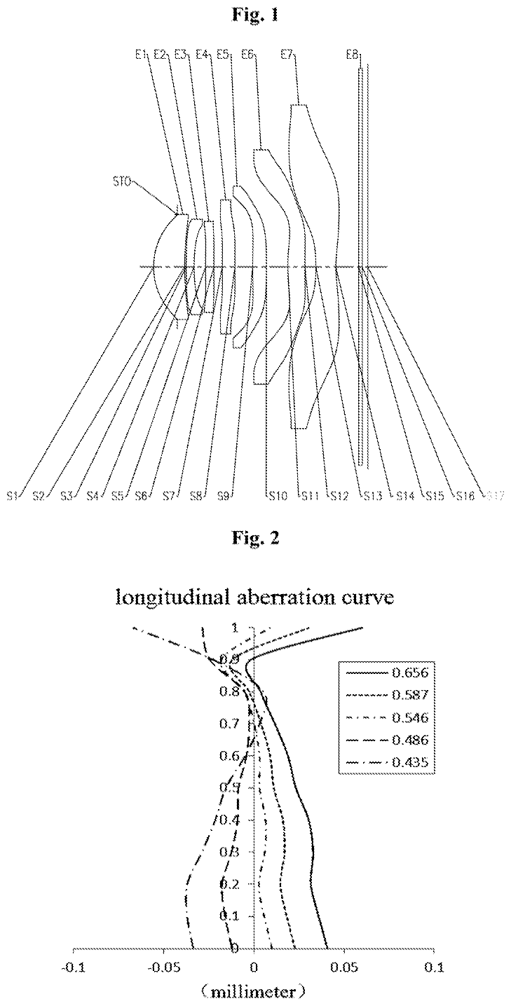

As shown in FIGS. 1-55, sequentially including from an object side to an image side along an optical axis: a first lens, a second lens, a third lens, a fourth lens, a fifth lens, a sixth lens, and a seventh lens, a first lens has a positive refractive power; a second lens has a negative refractive power; an object-side surface of the fifth lens is a convex surface side; and a seventh lens has a negative refractive power, wherein TTL is an on-axis distance from an object-side surface of the first lens to an imaging surface of the camera lens assembly, ImgH is a half of a diagonal length of an effective pixel region on the imaging surface, TTL, ImgH and an effective focal length f of the camera lens assembly satisfy: 6 mm<TTL*(ImgH/f)<7 mm; a center thickness CT4 of the fourth lens, a center thickness CT5 of the fifth lens and an air space T56 from the fifth lens to the sixth lens on the optical axis satisfy: 0.5<(CT4+CT5)/T56≤1.3.

By reasonable arrangement of refractive power, astigmatism and distortion may be effectively reduced, and an imaging quality of camera lens assembly may be greatly improved. By reasonably controlling the on-axis distance TTL from the object-side surface of the first lens to the imaging surface of the camera lens assembly, the half of the diagonal length ImgH of the effective pixel region on the imaging surface and the effective focal length f of the camera lens assembly, characteristics of large image surface and ultra-thinness for the camera lens assembly may be ensured. By reasonably controlling a ratio of the center thickness CT4 of the fourth lens, the center thickness CT5 of the fifth lens and an air space T56 from the fifth lens to the sixth lens on the optical axis, the distortion of the system may be reasonably controlled, so that the system has good distortion performance, high image quality of the system and the imaging quality of the camera lens assembly may be ensured.

In an exemplary embodiment, an on-axis distance TTL from the object-side surface of the first lens to the imaging surface of the camera lens assembly, the half of the diagonal length ImgH of an effective pixel region on the imaging surface and the effective focal length f of the camera lens assembly satisfy: 6.2 mm<TTL*(ImgH/f)≤6.7 mm.

In an exemplary embodiment, the center thickness CT4 of the fourth lens, the center thickness CT5 of the fifth lens and the air space T56 of the fifth lens to the sixth lens on the optical axis satisfy: 0.6<(CT4—CT5)/T56≤1.3.

In an exemplary embodiment, the effective focal length f of the camera lens assembly, a maximum half field of view HFOV of the camera lens assembly satisfy: f*tan(HFOV)≥5.4 mm. More specifically, the effective focal length f of the camera lens assembly and the maximum half field of view HFOV of the camera lens assembly satisfy: 5.4≤f*tan(HFOV)<6.0 mm. This arrangement ensures a characteristic of a large image surface of the camera lens assembly.

In an exemplary embodiment, an air space T23 from the second lens to the third lens on the optical axis, an air space T34 from the third lens to the fourth lens on the optical axis and an air space T45 from the fourth lens to the fifth lens on the optical axis satisfy: 1.9≤(T23+T45)/T34<4.0. More specifically, the air space T23 from the second lens to the third lens on the optical axis, the air space T34 from the third lens to the fourth lens on the optical axis and the air space T45 from the fourth lens to the fifth lens on the optical axis satisfy: 1.9≤(T23+T45)/T34<3.9. This arrangement may effectively ensure a structural feasibility of the system, and an installation of the camera lens assembly may be facilitated by arranging the air spaces T23, T34 and T45.

In an exemplary embodiment, the effective focal length f of the camera lens assembly and a curvature radius R9 of the object-side surface of the fifth lens satisfy: 0<f/R9≤2.0. More specifically, the effective focal length f of the camera lens assembly and the curvature radius R9 of the object-side surface of the fifth lens satisfy: 0.4<f/R9≤2.0. This arrangement may control astigmatism contribution of the object-side surface S9 of the fifth lens within a reasonable range, so as to balance the astigmatism accumulated before and after the system, and make the optical system have better imaging quality within tangential surface and sagittal surface.

In an exemplary embodiment, the effective focal length f of the camera lens assembly, a center thickness CT6 of the sixth lens, a center thickness CT7 of the seventh lens and an air space T67 from the sixth lens to the seventh lens on the optical axis satisfy: 3≤f/(CT6+T67+CT7)<4.5. More specifically, the effective focal length f of the camera lens assembly, the center thickness CT6 of the sixth lens, the center thickness CT7 of the seventh lens and the air space T67 from the sixth lens to the seventh lens on the optical axis satisfy: 3≤f/(CT6+T67+CT7)<4.4. This arrangement may reasonably restrain a contribution amount of the third-order distortion of the sixth lens E6 and the seventh lens E7, so that an image quality of an edge field of view is in a reasonable interval.

In an exemplary embodiment, a curvature radius R1 of an object-side surface of the first lens, a curvature radius R2 of an image-side surface of the first lens and a center thickness CT1 of the first lens satisfy: 3.5<|R1−R2|/CT1<8.5. More specifically, the curvature radius R1 of the object-side surface of the first lens, the curvature radius R2 of the image-side surface of the first lens and the center thickness CT1 of the first lens satisfy: 3.9<|R1−R2|/CT1<8.1. This enables the first lens E1 of the camera lens assembly to have a more reasonable shape, so as to reasonably assume a refractive power of the system, balance an aberration generated by the back lens, meanwhile, weaken the fourth total reflection ghost generated by the first lens E1.

In an exemplary embodiment, a maximum effective radius DT11 of an object-side surface of the first lens, a maximum effective radius DT61 of an object-side surface of the sixth lens and a maximum effective radius DT72 of an image-side surface of the seventh lens satisfy: 0.3<2*DT11/(DT61+DT72)<0.5. This arrangement may control the above conditional expression to a smaller range, ensure that the whole optical system has a smaller size, and ensure the miniaturization and thinness of the camera lens assembly.

In an exemplary embodiment, SAG11 is an on-axis distance from an intersection point of an object-side surface of the first lens and the optical axis to a maximum effective radius of the object-side surface of the first lens, SAG11, a center thickness CT1 of the first lens and an edge thickness ET1 of the first lens at the maximum effective radius satisfy: 1.5≤ET1/(CT1−SAG11)≤2.0. This arrangement enables the first lens E1 to satisfy the machinability while satisfying a size requirement of the lens barrel, which facilitates the assembly after molding.

In an exemplary embodiment, a combined focal length f67 of the sixth lens and the seventh lens, a curvature radius R11 of an object-side surface of the sixth lens and a curvature radius R14 of an image-side surface of the seventh lens satisfy: −2.5≤f67/(R11+R14)<−0.5. More specifically, the combined focal length f67 of the sixth lens and the seventh lens, the curvature radius R11 of the object-side surface of the sixth lens and the curvature radius R14 of the image-side surface of the seventh lens satisfy: −2.5≤f67/(R11+R14)<−0.7. This arrangement is beneficial to control a field curvature contribution of the object-side surface and the image-side surface thereof in a reasonable range to balance a field curvature generated by the front lens.

In an exemplary embodiment, SAG22 is an on-axis distance from an intersection point of an image-side surface of the second lens and the optical axis to a maximum effective radius of the image-side surface of the second lens, SAG22 and an edge thickness ET2 of the second lens at the maximum effective radius satisfy: 0.8<SAG22/ET2≤1.3. This arrangement may reasonably restrict the shape of the lens and ensure the manufacturability of the lens.

In an exemplary embodiment, the effective focal length f of the camera lens assembly, an effective focal length f3 of the third lens and an effective focal length f4 of the fourth lens satisfy: |f/f3+f/f4|<0.2. More specifically, the effective focal length f of the camera lens assembly, the effective focal length f3 of the third lens and the effective focal length f4 of the fourth lens satisfy: 0<|f/f3+f/f4|<0.2. This arrangement may contribute a reasonable negative third-order spherical aberration and a reasonable positive fifth-order spherical aberration, balance a positive third-order spherical aberration and a negative fifth-order spherical aberration generated by the third lens E3 and the fourth lens E4, make the system have a smaller spherical aberration, and ensure a good imaging quality of the on-axis field of view.

In an exemplary embodiment, the effective focal length f of the camera lens assembly and an effective focal length f5 of the fifth lens satisfy: −0.1<f/f5<0.5. More specifically, the effective focal length f of the camera lens assembly and the effective focal length f5 of the fifth lens satisfy: −0.1<f/f5<0.4. This arrangement may balance a refractive power generated by the fifth lens E5 and a refractive power generated by the front end optical group, so as to achieve goals of reducing aberration and improving the imaging quality.

In an exemplary embodiment, the effective focal length f1 of the first lens, an effective focal length f2 of the second lens and an effective focal length f7 of the seventh lens satisfy: −4.5≤(f2+f7)/f1<−3.0. More specifically, the effective focal length f1 of the first lens, the effective focal length f2 of the second lens and the effective focal length f7 of the seventh lens satisfy: −4.5≤(f2+f7)/f1<−3.2. This arrangement reasonably distributes refractive power of each lens of the system, balances an aberration of the system, and ensures a high image quality of the system.

In an exemplary embodiment, a center thickness CT2 of the second lens, a center thickness CT3 of the third lens, the center thickness CT4 of the fourth lens, and the center thickness CT5 of the fifth lens satisfy: 0.3 mm≤(CT2+CT3+CT4+CT5)/4≤0.35 mm. This arrangement makes that center thicknesses of the second lens E2, the third lens E3, the fourth lens E4 and the fifth lens E5 are constrained within a reasonable range, which not only ensures that each lens satisfies a processing performance, but also ensures an ultra-thinness characteristic of each lens.

### Embodiment 2

It sequentially includes from an object side to an image side along an optical axis: a first lens, a second lens, a third lens, a fourth lens, a fifth lens, a sixth lens, and a seventh lens, a first lens has a positive refractive power; a second lens has a negative refractive power; an object-side surface of the fifth lens is a convex surface side; and a seventh lens has a negative refractive power, wherein a maximum effective radius DT11 of an object-side surface of the first lens, a maximum effective radius DT61 of an object-side surface of the sixth lens and a maximum effective radius DT72 of an image-side surface of the seventh lens satisfy: 0.3<2*DT11/(DT61+DT72)<0.5; a center thickness CT4 of the fourth lens, a center thickness CT5 of the fifth lens and an air space T56 from the fifth lens to the sixth lens on the optical axis satisfy: 0.5<(CT4+CT5)/T56≤1.3.

By controlling 2*DT11/(DT61+DT72) to a smaller range, the whole optical system may be ensured to have a smaller size, and a miniaturization and a thinning of the camera lens assembly may be ensured. By reasonably controlling a ratio of the center thickness CT4 of the fourth lens and the center thickness CT5 of the fifth lens to the air space T56 from the fifth lens to the sixth lens on the optical axis, a distortion of the system may be reasonably controlled, so that a good distortion performance and an high image quality of the system may be ensured, and an imaging quality of the camera lens assembly may be ensured.

In an exemplary embodiment, the center thickness CT4 of the fourth lens, the center thickness CT5 of the fifth lens and the air space T56 of the fifth lens to the sixth lens on the optical axis satisfy: 0.6<(CT4+CT5)/T56≤1.3.

In an exemplary embodiment, TTL is an on-axis distance from the object-side surface of the first lens to an imaging surface of the camera lens assembly, ImgH is a half of a diagonal length of an effective pixel region on the imaging surface, TTL, ImgH and an effective focal length f of the camera lens assembly satisfy: 6 mm<TTL*(ImgH/f)<7 mm. More specifically, the on-axis distance TTL from the object-side surface of the first lens to the imaging surface of the camera lens assembly, the half of the diagonal length ImgH of the effective pixel region on the imaging surface and the effective focal length f of the camera lens assembly satisfy: 6.2 mm<TTL*(ImgH/f)≤6.7 mm. By reasonably controlling the on-axis distance TTL from the object-side surface of the first lens to the imaging surface of the camera lens assembly, the half of the diagonal length ImgH of the effective pixel region on the imaging surface and the effective focal length f of the camera lens assembly, characteristics of large image surface and ultra-thinness for the camera lens assembly may be ensured.

In an exemplary embodiment, an effective focal length f of the camera lens assembly and a maximum half field of view HFOV of the camera lens assembly satisfy: f*tan(HFOV)≥5.4 mm. More specifically, the effective focal length f of the camera lens assembly and the maximum half field of view HFOV of the camera lens assembly satisfy: 5.4 mm≤f*tan(HFOV)<6.0 mm. This arrangement ensures a characteristic of a large image surface of the camera lens assembly.

In an exemplary embodiment, an air space T23 from the second lens to the third lens on the optical axis, an air space T34 from the third lens to the fourth lens on the optical axis and an air space T45 from the fourth lens to the fifth lens on the optical axis satisfy: 1.9≤(T23+T45)/T34<4.0. More specifically, the air space T23 from the second lens to the third lens on the optical axis, the air space T34 from the third lens to the fourth lens on the optical axis and the air space T45 from the fourth lens to the fifth lens on the optical axis satisfy: 1.9≤(T23+T45)/T34<3.9. This arrangement may effectively ensure a structural feasibility of the system, and the camera lens assembly may easy be assembled by arranging the air spaces T23, T34 and T45.

In an exemplary embodiment, an effective focal length f of the camera lens assembly and a curvature radius R9 of the object-side surface of the fifth lens satisfy: 0<f/R9≤2.0. More specifically, the effective focal length f of the camera lens assembly and the curvature radius R9 of the object-side surface of the fifth lens satisfy: 0.4<f/R9≤2.0. This arrangement may control the astigmatism contribution of the object-side surface S9 of the fifth lens within a reasonable range, so as to balance the astigmatism accumulated before and after the system, and make the optical system have a better imaging quality within a tangential surface and a sagittal surface.

In an exemplary embodiment, the effective focal length f of the camera lens assembly, a center thickness CT6 of the sixth lens, a center thickness CT7 of the seventh lens and an air space T67 from the sixth lens to the seventh lens on the optical axis satisfy: 3≤f/(CT6+T67+CT7)<4.5. More specifically, the effective focal length f of the camera lens assembly, the center thickness CT6 of the sixth lens, the center thickness CT7 of the seventh lens and the air space T67 from the sixth lens to the seventh lens on the optical axis satisfy: 3≤f/(CT6+T67+CT7)<4.4. This arrangement may reasonably restrain a contribution amount of the third-order distortion of the sixth lens E6 and the seventh lens E7, so that an image quality of an edge field of view is in a reasonable interval.

In an exemplary embodiment, a curvature radius R1 of an object-side surface of the first lens, a curvature radius R2 of an image-side surface of the first lens and a center thickness CT1 of the first lens satisfy: 3.5<|R1−R2|/CT1<8.5. More specifically, the curvature radius R1 of the object-side surface of the first lens, the curvature radius R2 of the image-side surface of the first lens and the center thickness CT1 of the first lens satisfy: 3.9<|R1−R21/CT1<8.1. This enables the first lens E1 of the camera lens assembly to have a more reasonable shape, so as to reasonably assume a refractive power of the system, balance an aberration generated by the back lens, meanwhile, weaken the fourth total reflection ghost generated by the first lens E1.

In an exemplary embodiment, a center thickness CT1 of the first lens, an edge thickness ET1 of the first lens at the maximum effective radius, and an on-axis distance SAG11 from an intersection of an object-side surface of the first lens and the optical axis to the object-side surface of the first lens at the maximum effective radius satisfy: 1.5≤ET1/(CT1−SAG11)≤2.0. This arrangement enables the first lens E1 to satisfy the machinability and the size requirements of the lens barrel, which facilitates the assembly after molding.

In an exemplary embodiment, a combined focal length f67 of the sixth lens and the seventh lens, a curvature radius R11 of an object-side surface of the sixth lens and a curvature radius R14 of an image-side surface of the seventh lens satisfy: −2.5≤f67/(R11+R14)<−0.5. More specifically, the combined focal length f67 of the sixth lens and the seventh lens, the curvature radius R11 of the object-side surface of the sixth lens and the curvature radius R14 of the image-side surface of the seventh lens satisfy: −2.5≤f67/(R11+R14)<−0.7. This arrangement is beneficial to control field curvature contribution of the object-side surface and the image-side surface thereof in a reasonable range to balance a field curvature generated by the front lens.

In an exemplary embodiment, SAG22 is an on-axis distance from an intersection point of an image-side surface of the second lens and the optical axis to a maximum effective radius of the image-side surface of the second lens, SAG22 and an edge thickness ET2 of the second lens at the maximum effective radius satisfy: 0.8<SAG22/ET2≤1.3. This arrangement may reasonably restrict a shape of the lens and ensure a manufacturability of the lens.

In an exemplary embodiment, an effective focal length f of the camera lens assembly, an effective focal length f3 of the third lens and an effective focal length f4 of the fourth lens satisfy: |f/f3+f/f4|<0.2. More specifically, the effective focal length f of the camera lens assembly, the effective focal length f3 of the third lens and the effective focal length f4 of the fourth lens satisfy: 0<|f/f3+f/f4|<0.2. This arrangement may contribute a reasonable negative third-order spherical aberration and a reasonable positive fifth-order spherical aberration, balance a positive third-order spherical aberration and a negative fifth-order spherical aberration generated by the third lens E3 and the fourth lens E4, make the system have a smaller spherical aberration, and ensure a good imaging quality of the on-axis field of view.

In an exemplary embodiment, an effective focal length f of the camera lens assembly and an effective focal length f5 of the fifth lens satisfy: −0.1<f/f5<0.5. More specifically, the effective focal length f of the camera lens assembly and the effective focal length f5 of the fifth lens satisfy: −0.1<f/f5<0.4. This arrangement may balance a refractive power generated by the fifth lens E5 and a refractive power generated by the front end optical group, so as to achieve goals of reducing aberration and improving the imaging quality.

In an exemplary embodiment, an effective focal length f1 of the first lens, an effective focal length f2 of the second lens and an effective focal length f7 of the seventh lens satisfy: −4.5≤(f2+f7)/f1<−3.0. More specifically, the effective focal length f1 of the first lens, the effective focal length f2 of the second lens and the effective focal length f7 of the seventh lens satisfy: −4.5≤(f2+f7)/f1<−3.2. This arrangement reasonably distributes refractive power of each lens of the system, balances an aberration of the system, and ensures a high image quality of the system.

In an exemplary embodiment, a center thickness CT2 of the second lens, a center thickness CT3 of the third lens, the center thickness CT4 of the fourth lens, and the center thickness CT5 of the fifth lens satisfy: 0.3 mm≤(CT2+CT3+CT4+CT5)/4≤0.35 mm. This arrangement makes that center thicknesses of the second lens E2, the third lens E3, the fourth lens E4 and the fifth lens E5 are constrained within a reasonable range, which not only ensures that each lens satisfies a processing performance, but also ensures an ultra-thinness characteristic of each lens.

The above camera lens assembly may further include at least one diaphragm STO to improve an imaging quality of the lens. In an embodiment, the diaphragm STO may be arranged in front of the first lens E1. In another embodiment, the above camera lens assembly may further include an optical filter E8 for correcting color deviation and/or a protective glass for protecting photosensitive elements located on the imaging surface.

The camera lens assembly of the disclosure may adopt multiple lenses, such as the above seven lenses. By reasonably distributing refractive power of each lens, surface shape, center thickness of each lens and on-axis distance between each lens, an aperture size of the camera lens assembly may be effectively increased, a sensitivity of the lens may be reduced, and a processability of the lens may be improved, which makes the camera lens assembly more conducive to production and processing and may be suitable for portable electronic devices such as smart phones. The above camera lens assembly also has a large aperture size. The advantages of ultra-thinness and good imaging quality may satisfy the requirements of intelligent electronic products miniaturization.

In the disclosure, at least one of the mirror surfaces of each lens is an aspheric mirror surface. The characteristic of aspheric lens is that the curvature changes continuously from the center of lens to the periphery of lens. Different from the spherical lens with constant curvature from the center of the lens to the periphery of the lens, the aspheric lens has better curvature radius characteristics and has advantages of improving distortion aberration and astigmatism aberration. After adopting aspheric lens, the aberration during imaging may be eliminated as much as possible, thus improving the imaging quality.

However, those skilled in the art should understand that the number of lens constituting the camera lens assembly may be changed to obtain the results and advantages described in this description without departing from the technical solution claimed in the disclosure. For example, although seven lenses have been described as an example in the embodiment, the camera lens assembly is not limited to seven lenses. If necessary, the camera lens assembly may further include other numbers of lens.

Examples of specific surface shapes and parameters of the camera lens assembly that may be applied to the above embodiments will be further described below with reference to the drawings.

It should be noted that any one of the following Example 1 to Example 11 is applicable to all the embodiments of the disclosure.

### EXAMPLE 1

As shown in FIGS. 1-5, a camera lens assembly in Example 1 of the disclosure is described. FIG. 1 shows a structural schematic diagram of the camera lens assembly in Example 1.

As shown in FIG. 1, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a concave surface. The fifth lens E5 has a positive refractive power, an object-side surface S9 of the fifth lens is a convex surface, and an image-side surface S10 of the fifth lens is a convex surface. The sixth lens E6 has a positive refractive power, an object-side surface S11 of the sixth lens is a convex surface, and an image-side surface S12 of the sixth lens is a convex surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.01 mm, a maximum field of view FOV of the camera lens assembly is 84.9°, ImgH is a half of a diagonal length of an effective pixel region on the imaging surface S17, and ImgH is 6.15 mm.

Table 1 shows a basic structure parameter table of the camera lens assembly in Example 1, wherein the units of curvature radius, thickness/distance and focal length are all millimeters (mm).

TABLE 1

| | | | | Material | | |
|---|---|---|---|---|---|---|
| Surface | | | | Refractive | Abbe | Conic |
| number | Surface type | Curvature radius | Thickness | index | number | coefficient |
| OBJ | Spherical | Infinity | Infinity | | | |
| STO | Spherical | Infinity | −0.7395 | | | |
| S1 | Aspheric | 2.0529 | 0.9702 | 1.536 | 55.60 | 0.0000 |
| S2 | Aspheric | 7.1166 | 0.0464 | | | 0.0000 |
| S3 | Aspheric | 13.1533 | 0.2500 | 1.677 | 19.20 | 0.0000 |
| S4 | Aspheric | 5.4767 | 0.3580 | | | 0.0000 |
| S5 | Aspheric | 22.2199 | 0.2600 | 1.677 | 19.20 | 0.0000 |
| S6 | Aspheric | 29.3854 | 0.2641 | | | 0.0000 |
| S7 | Aspheric | 27.4898 | 0.3938 | 1.536 | 55.60 | 0.0000 |
| S8 | Aspheric | 29.4290 | 0.5554 | | | 0.0000 |
| S9 | Aspheric | 14.7211 | 0.4300 | 1.560 | 39.93 | 0.0000 |
| S10 | Aspheric | −54.3958 | 0.6693 | | | 0.0000 |
| S11 | Aspheric | 5.6638 | 0.5380 | 1.536 | 55.60 | 0.0000 |
| S12 | Aspheric | −377.9994 | 0.3404 | | | 0.0000 |
| S13 | Aspheric | −6.2914 | 0.6220 | 1.544 | 56.00 | 0.0000 |
| S14 | Aspheric | 3.1389 | 0.7176 | | | −1.0000 |
| S15 | Spherical | Infinity | 0.1100 | 1.519 | 64.17 | |
| S16 | Spherical | Infinity | 0.1747 | | | |
| S17 | Spherical | Infinity | | | | |

In Example 1, both of the object-side surface and the image-side surface of any one of the first lens E1 to the seventh lens E7 are aspheric surfaces, and a surface type of each aspheric lens may be defined by the following aspheric surface formula, but not limited to:

$$x = \frac{{ch}^{2}}{1 + \sqrt{1 - ( k + 1 ) {c}^{2} {h}^{2}}} + \sum {Aih}^{′} \qquad ( 1 )$$

wherein x is a distance vector height from a vertex of the aspheric surface when the aspheric surface is at a height of h along the optical axis 10; c is a paraxial curvature of the aspheric surface, c=1/R (that is, the paraxial curvature c is a reciprocal of the curvature radius R in Table 1 above); K is a conic coefficient; Ai is a correction coefficient of the i-th order of the aspheric surface. The following Table 2 provides high-order term coefficients A4, A6, A8, A10, A12, A14, A16, A18, A20, A22, A24, A26, A28 and A30 that may be used for each of the aspheric mirror surfaces S1-S14 in Example 1.

TABLE 2

| Surface number | A4 | A6 | A8 | A10 | A12 | A14 | A16 |
|---|---|---|---|---|---|---|---|
| S1 | 6.1280E−03 | −3.8032E−03 | −3.0000E−03 | −1.1651E−03 | −3.7061E−04 | −7.7057E−05 | −1.8029E−05 |
| S2 | −5.0515E−02 | 8.6109E−03 | −1.6027E−03 | −9.4659E−04 | −3.3991E−04 | −1.2029E−04 | −2.1747E−05 |
| S3 | 4.3137E−02 | 2.0514E−02 | 2.8879E−03 | 7.1237E−04 | 4.7710E−05 | −5.1516E−05 | −2.8951E−05 |
| S4 | 7.3008E−02 | 1.0552E−02 | 2.1765E−03 | 7.9333E−04 | 2.1978E−04 | 6.6060E−05 | 1.1340E−05 |
| S5 | −1.1250E−01 | 5.5088E−04 | 2.2343E−03 | 2.0466E−04 | −2.6108E−04 | −1.1951E−04 | −1.7268E−05 |
| S6 | −6.5852E−02 | 1.0535E−02 | 3.1083E−03 | 4.6571E−04 | −2.3397E−05 | 3.3519E−05 | 1.8896E−05 |
| S7 | −1.6217E−01 | 5.4491E−02 | −2.2914E−03 | −5.0942E−03 | −4.2443E−05 | 5.4113E−04 | −2.9347E−04 |
| S8 | −2.7217E−01 | 7.8906E−02 | 3.0329E−03 | −7.1713E−03 | −1.4417E−03 | 5.6905E−04 | −2.6743E−04 |
| S9 | −7.6212E−01 | −3.5794E−02 | 1.6876E−02 | 7.7534E−03 | 5.2144E−03 | 6.4159E−03 | 3.2474E−03 |
| S10 | −8.1350E−01 | 1.0996E−01 | −1.2074E−03 | −1.6694E−02 | −2.0450E−03 | 5.8692E−03 | 1.3110E−03 |
| S11 | −2.5893E+00 | 6.3549E−01 | −2.1685E−02 | −6.4367E−02 | 2.7492E−02 | −8.0129E−03 | 3.6524E−03 |
| S12 | −1.3748E+00 | 2.6789E−01 | −7.4398E−02 | 3.6974E−02 | 2.1894E−02 | −2.1715E−02 | 1.6089E−02 |
| S13 | 1.1616E+00 | 3.5189E−01 | −3.1776E−01 | 2.1019E−01 | −1.3033E−01 | 6.6598E−02 | −3.7689E−02 |
| S14 | −6.1077E+00 | 1.5581E+00 | −4.4620E−01 | 1.4317E−01 | −1.0038E−01 | 5.9305E−02 | −5.1530E−02 |
| Surface number | A18 | A20 | A22 | A24 | A26 | A28 | A30 |
| S1 | −4.8185E−06 | 1.1075E−06 | 9.5802E−07 | 4.2465E−09 | −4.7166E−07 | 1.0406E−09 | 0.0000E+00 |
| S2 | 2.3628E−05 | −6.7091E−06 | 6.9300E−06 | −1.9278E−10 | 0.0000E+00 | 0.0000E+00 | 0.0000E+00 |
| S3 | 9.6510E−06 | −4.9855E−06 | 2.7936E−07 | 0.0000E+00 | 0.0000E+00 | 0.0000E+00 | 0.0000E+00 |
| S4 | 5.9257E−06 | −3.5469E−06 | −9.7320E−08 | 0.0000E+00 | 0.0000E+00 | 0.0000E+00 | 0.0000E+00 |
| S5 | 4.5668E−05 | 6.2430E−05 | 3.1362E−05 | 1.7485E−06 | −1.8754E−05 | −1.6955E−05 | −7.1440E−06 |
| S6 | 1.8363E−06 | 4.0756E−06 | −1.0580E−06 | −1.5480E−06 | −1.5972E−06 | 7.0376E−07 | 5.4224E−07 |
| S7 | −3.0564E−04 | −8.6045E−05 | −7.9425E−05 | −6.4619E−05 | −4.0829E−05 | −9.5160E−06 | −7.6864E−06 |
| S8 | −3.5853E−04 | −7.9890E−05 | −2.8758E−05 | −2.2548E−05 | −7.0155E−06 | 1.9555E−05 | 1.5846E−05 |
| S9 | −7.0579E−04 | −1.4999E−03 | −8.3733E−04 | −1.9070E−04 | −2.0142E−05 | 1.8626E−05 | 3.4462E−05 |
| S10 | −2.0347E−03 | −1.4145E−04 | 8.3239E−04 | 2.6902E−04 | −1.9623E−04 | −1.0831E−04 | 8.7783E−05 |
| S11 | 5.2811E−04 | 1.5569E−04 | −1.5266E−03 | 3.4235E−04 | 5.7540E−04 | −3.0896E−04 | 1.7664E−05 |
| S12 | −1.1693E−02 | 5.3807E−03 | −2.1645E−04 | 8.3297E−04 | −4.4805E−05 | −5.1906E−04 | 3.8176E−05 |
| S13 | 1.8661E−02 | −4.0132E−03 | −1.2740E−03 | 3.3065E−03 | −2.1364E−03 | 9.7331E−04 | −1.5077E−04 |
| S14 | 2.5102E−02 | −1.0528E−02 | 1.0816E−02 | −2.8075E−03 | 5.3511E−04 | −9.8899E−04 | 2.6548E−04 |

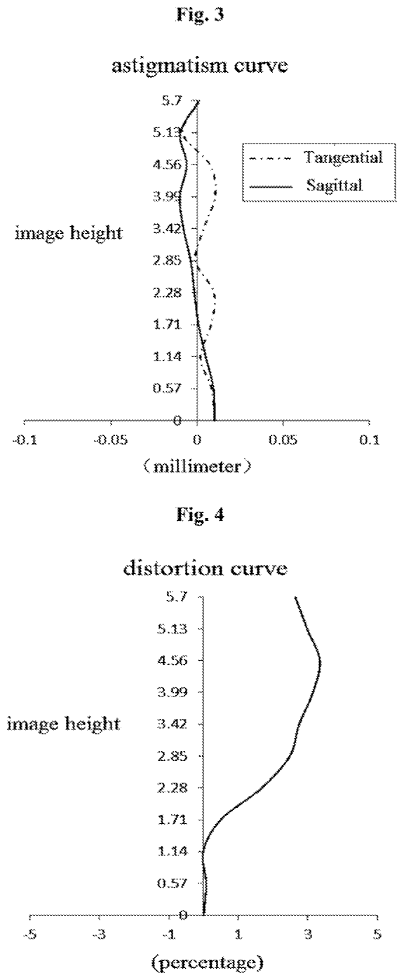

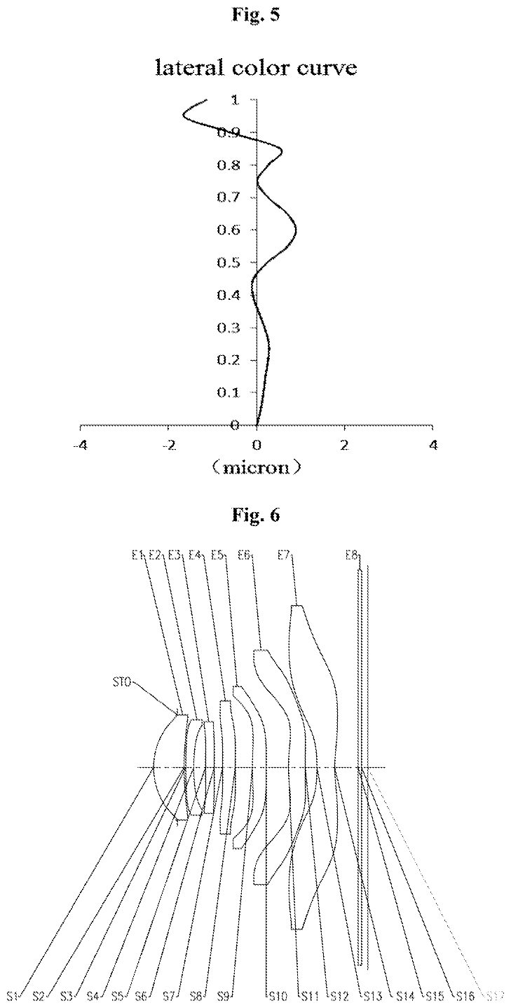

FIG. 2 shows a longitudinal aberration curve of the camera lens assembly of Example 1, which represents deviations of a convergence focal point after light with different wavelengths passes through the camera lens assembly. FIG. 3 shows an astigmatism curve of the camera lens assembly of Example 1, which represents a tangential image surface curvature and a sagittal image surface curvature. FIG. 4 shows a distortion curve of the camera lens assembly of Example 1, which represents distortion values corresponding to different fields of view. FIG. 5 shows a lateral color curve of the camera lens assembly of Example 1, which represents deviations of different image heights on the imaging surface after the light passes through the camera lens assembly.

According to FIGS. 2-5, it can be seen that the camera lens assembly provided in Example 1 may achieve good imaging quality.

### EXAMPLE 2

As shown in FIGS. 6-10, the camera lens assembly in Example 2 of the disclosure is described. In this example and the following examples, for the sake of brevity, some descriptions similar to Example 1 will be omitted. FIG. 6 shows a structural schematic diagram of a camera lens assembly in Example 2.

As shown in FIG. 6, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a negative refractive power, an object-side surface S7 of the fourth lens is a convex surface, and an image-side surface S8 of the fourth lens is a concave surface. The fifth lens E5 has a positive refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a convex surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.01 mm, a maximum field of view FOV of the camera lens assembly is 84.9°, ImgH is a half of a diagonal length of an effective pixel region on the imaging surface S17, and ImgH is 5.70 mm.

Table 3 shows a basic structure parameter table of the camera lens assembly of Example 2, wherein the units of curvature radius, thickness/distance and focal length are all millimeters (mm).

TABLE 3

| | | | | Material | | |
|---|---|---|---|---|---|---|
| Surface | | | | Refractive | Abbe | Conic |
| number | Surface type | Curvature radius | Thickness | index | number | coefficient |
| OBJ | Spherical | Infinity | Infinity | | | |
| STO | Spherical | Infinity | −0.7411 | | | |
| S1 | Aspheric | 2.0554 | 0.9533 | 1.536 | 55.61 | 0.0000 |
| S2 | Aspheric | 7.2191 | 0.0514 | | | 0.0000 |
| S3 | Aspheric | 13.0047 | 0.2508 | 1.676 | 19.29 | 0.0000 |
| S4 | Aspheric | 5.5057 | 0.3712 | | | 0.0000 |
| S5 | Aspheric | 27.5853 | 0.2678 | 1.677 | 19.20 | 0.0000 |
| S6 | Aspheric | 32.1757 | 0.2623 | | | 0.0000 |
| S7 | Aspheric | 27.0257 | 0.3966 | 1.536 | 55.52 | 0.0000 |
| S8 | Aspheric | 18.6088 | 0.5369 | | | 0.0000 |
| S9 | Aspheric | 8.0408 | 0.4325 | 1.564 | 38.86 | 0.0000 |
| S10 | Aspheric | 37.3242 | 0.6966 | | | 0.0000 |
| S11 | Aspheric | 5.5356 | 0.5253 | 1.536 | 55.60 | 0.0000 |
| S12 | Aspheric | −54.7659 | 0.3648 | | | 0.0000 |
| S13 | Aspheric | −6.1357 | 0.5509 | 1.537 | 55.63 | 0.0000 |
| S14 | Aspheric | 3.1326 | 0.7363 | | | −1.0000 |
| S15 | Spherical | Infinity | 0.1100 | 1.519 | 64.17 | |
| S16 | Spherical | Infinity | 0.1934 | | | |
| S17 | Spherical | Infinity | | | | |

Table 4 shows high-order term coefficients that can be used for each aspheric mirror surface in Example 2, wherein a surface type of each aspheric surface may be defined by the formula (1) provided in Example 1 above.

TABLE 4

| Surface number | A4 | A6 | A8 | A10 | A12 | A14 | A16 |
|---|---|---|---|---|---|---|---|
| S1 | 6.3354E−03 | −3.9157E−03 | −3.0130E−03 | −1.1582E−03 | −3.6043E−04 | −7.4919E−05 | −1.2737E−05 |
| S2 | −4.7566E−02 | 7.7862E−03 | −1.4877E−03 | −8.4297E−04 | −3.6806E−04 | −1.0916E−04 | −4.3861E−05 |
| S3 | 4.6720E−02 | 1.9784E−02 | 2.9672E−03 | 7.5056E−04 | 4.2688E−05 | −2.8441E−05 | −3.9553E−05 |
| S4 | 7.3625E−02 | 1.0457E−02 | 2.2068E−03 | 7.7561E−04 | 2.0776E−04 | 6.4066E−05 | 5.6674E−06 |
| S5 | −1.1019E−01 | 1.9229E−04 | 2.3543E−03 | 1.9081E−04 | −2.9348E−04 | −1.2407E−04 | −1.2072E−06 |
| S6 | −6.5637E−02 | 1.0804E−02 | 2.9223E−03 | 6.0426E−04 | −9.4118E−05 | 3.0898E−05 | 1.2745E−05 |
| S7 | −1.8487E−01 | 6.2089E−02 | −4.8867E−03 | −4.0212E−03 | −7.2293E−04 | 8.1551E−04 | −3.6469E−04 |
| S8 | −3.4600E−01 | 9.6130E−02 | −2.8483E−03 | −4.6441E−03 | −2.7156E−03 | 1.0506E−03 | −4.8627E−04 |
| S9 | −9.1382E−01 | −4.0543E−03 | 7.2137E−03 | 1.0863E−02 | 3.6495E−03 | 7.2862E−03 | 2.8350E−03 |
| S10 | −9.6335E−01 | 1.4579E−01 | −1.2272E−02 | −1.2797E−02 | −3.9170E−03 | 7.1928E−03 | 6.8050E−04 |
| S11 | −2.6389E+00 | 6.4115E−01 | −2.3536E−02 | −6.4149E−02 | 2.6390E−02 | −6.4335E−03 | 2.9368E−03 |
| S12 | −1.2831E+00 | 2.3015E−01 | −5.1699E−02 | 2.7287E−02 | 2.6852E−02 | −2.4954E−02 | 1.7889E−02 |
| S13 | 1.2381E+00 | 3.6398E−01 | −3.1779E−01 | 2.1239E−01 | −1.3068E−01 | 6.3686E−02 | −3.5154E−02 |
| S14 | −6.1758E+00 | 1.5963E+00 | −4.6594E−01 | 1.4565E−01 | −1.0178E−01 | 5.7939E−02 | −5.5479E−02 |
| Surface number | A18 | A20 | A22 | A24 | A26 | A28 | A30 |
| S1 | −3.0714E−06 | −8.9776E−07 | 7.5998E−07 | −2.6493E−08 | −4.7724E−07 | 8.5687E−11 | 0.0000E+00 |
| S2 | 3.2195E−05 | −8.3655E−06 | 5.6374E−06 | −3.5896E−09 | 0.0000E+00 | 0.0000E+00 | 0.0000E+00 |
| S3 | 1.3073E−05 | −6.7875E−06 | 2.6825E−07 | 0.0000E+00 | 0.0000E+00 | 0.0000E+00 | 0.0000E+00 |
| S4 | 4.8518E−06 | −1.8722E−06 | −6.7948E−08 | 0.0000E+00 | 0.0000E+00 | 0.0000E+00 | 0.0000E+00 |
| S5 | 4.6126E−05 | 6.6806E−05 | 2.4874E−05 | 3.6181E−06 | −1.9395E−05 | −1.6238E−05 | −8.6990E−06 |
| S6 | 4.6470E−06 | 9.0395E−06 | −1.5558E−06 | −8.6396E−07 | −2.1286E−06 | 1.0318E−06 | 5.4234E−07 |
| S7 | −2.4153E−04 | −1.1778E−04 | −8.1661E−05 | −8.2399E−05 | −4.3195E−05 | −7.4721E−06 | 1.9813E−06 |
| S8 | −1.9534E−04 | −1.3633E−04 | 1.4139E−05 | −5.1106E−05 | 1.8728E−06 | 5.8209E−06 | 2.8365E−05 |
| S9 | −6.5143E−04 | −1.5888E−03 | −7.4584E−04 | −1.7290E−04 | −6.3580E−07 | 2.1526E−05 | 3.5175E−05 |
| S10 | −1.9708E−03 | −1.8823E−04 | 8.9675E−04 | 2.2688E−04 | −2.1027E−04 | −8.5716E−05 | 8.7053E−05 |
| S11 | 3.3944E−04 | 5.5828E−04 | −1.8510E−03 | 5.8281E−04 | 5.5179E−04 | −4.0200E−04 | 5.9862E−05 |
| S12 | −1.2190E−02 | 6.4109E−03 | −1.0071E−03 | 1.2750E−03 | −4.6943E−04 | −4.5061E−04 | 1.6310E−04 |
| S13 | 1.6825E−02 | −2.7810E−03 | −2.9866E−03 | 4.9036E−03 | −3.2448E−03 | 1.4505E−03 | −3.3344E−04 |
| S14 | 2.7513E−02 | −8.9461E−03 | 9.7927E−03 | −4.1273E−03 | 1.2173E−03 | −1.9896E−04 | 6.2265E−05 |

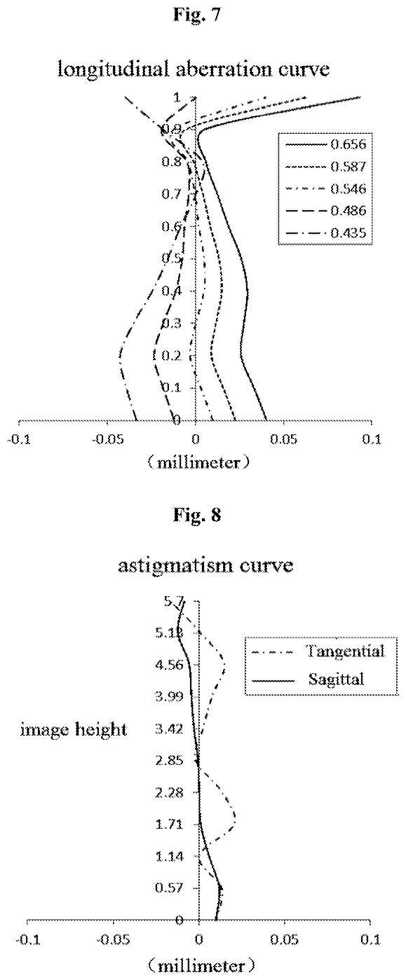

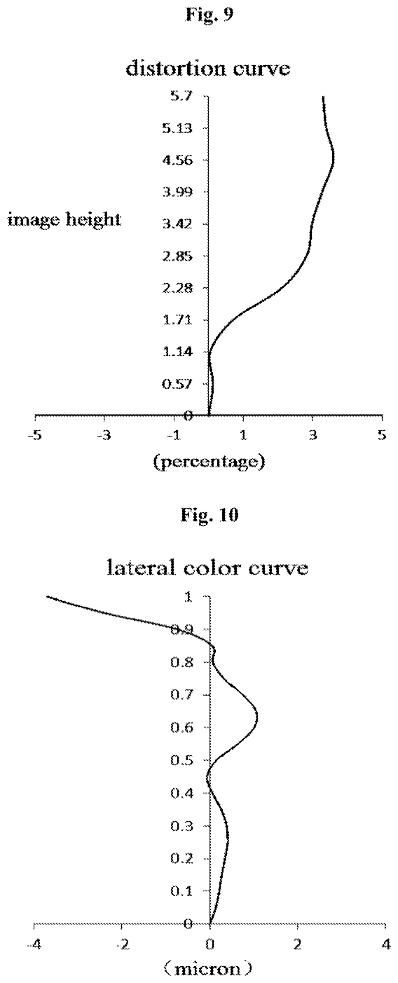

FIG. 7 shows a longitudinal aberration curve of the camera lens assembly of Example 2, which represents deviations of a convergence focal point after light with different wavelengths passes through the camera lens assembly. FIG. 8 shows an astigmatism curve of the camera lens assembly of Example 2, which represents a tangential image surface curvature and a sagittal image surface curvature. FIG. 9 shows a distortion curve of the camera lens assembly of Example 2, which represents distortion values corresponding to different fields of view. FIG. 10 shows a lateral color curve of the camera lens assembly of Example 2, which represents deviations of different image heights on the imaging surface after the light passes through the camera lens assembly.

According to FIGS. 7-10, it can be seen that the camera lens assembly provided in Example 2 may achieve good imaging quality.

### EXAMPLE 3

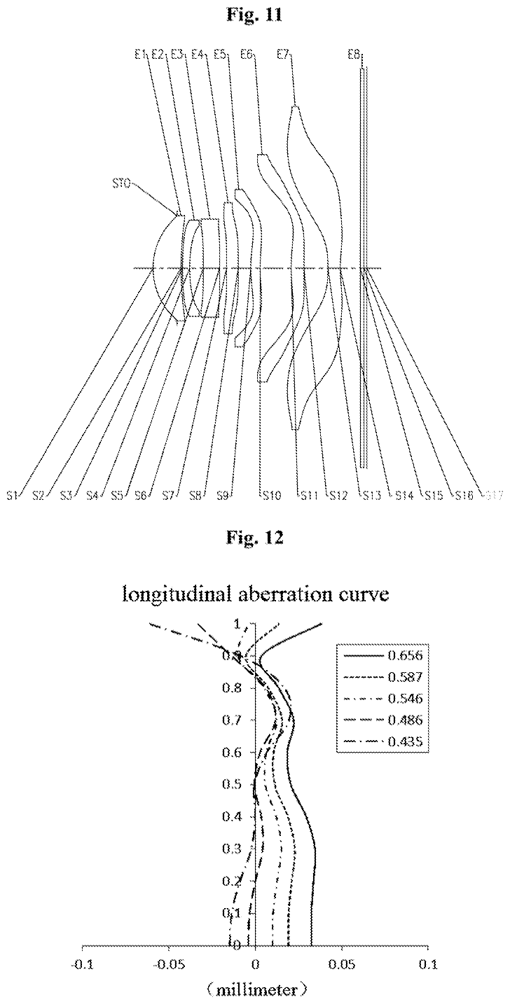

As shown in FIGS. 11-15, the camera lens assembly in Example 3 of the disclosure is described. In this example and the following examples, for the sake of brevity, some descriptions similar to Example 1 will be omitted. FIG. 11 shows a structural schematic diagram of a camera lens assembly in Example 3.

As shown in FIG. 11, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a negative refractive power, an object-side surface S5 of the third lens is a concave surface, and an image-side surface S6 of the third lens is a concave surface. The fourth lens E4 has a negative refractive power, an object-side surface S7 of the fourth lens is a convex surface, and an image-side surface S8 of the fourth lens is a concave surface. The fifth lens E5 has a positive refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.06 mm, a maximum field of view FOV of the camera lens assembly is 84.9°, ImgH is a half of a diagonal length of an effective pixel region on the imaging surface S17, and ImgH is 5.73 mm.

Table 5 shows a basic structure parameter table of the camera lens assembly of Example 3, wherein the units of curvature radius, thickness/distance and focal length are all millimeters (mm).

TABLE 5

| | | | | Material | | |
|---|---|---|---|---|---|---|
| Surface | | | | Refractive | Abbe | Conic |
| number | Surface type | Curvature radius | Thickness | index | number | coefficient |
| OBJ | Spherical | Infinity | Infinity | | | |
| STO | Spherical | Infinity | −0.7530 | | | |
| S1 | Aspheric | 2.0916 | 0.8775 | 1.536 | 55.60 | 0.0000 |
| S2 | Aspheric | 9.1305 | 0.0441 | | | 0.0000 |
| S3 | Aspheric | 9.2888 | 0.2249 | 1.677 | 19.21 | 0.0000 |
| S4 | Aspheric | 4.5078 | 0.4268 | | | 0.0000 |
| S5 | Aspheric | −118.6003 | 0.5126 | 1.676 | 19.28 | 0.0000 |
| S6 | Aspheric | 74.9047 | 0.2159 | | | 0.0000 |
| S7 | Aspheric | 52.6491 | 0.3657 | 1.536 | 55.46 | 0.0000 |
| S8 | Aspheric | 43.7573 | 0.3932 | | | 0.0000 |
| S9 | Aspheric | 3.6567 | 0.2954 | 1.580 | 35.38 | 0.0000 |
| S10 | Aspheric | 5.3417 | 0.9712 | | | 0.0000 |
| S11 | Aspheric | 5.4918 | 0.4019 | 1.538 | 53.71 | 0.0000 |
| S12 | Aspheric | 37.7171 | 0.7523 | | | 0.0000 |
| S13 | Aspheric | −6.0142 | 0.3808 | 1.536 | 55.60 | 0.0000 |
| S14 | Aspheric | 3.2496 | 0.6352 | | | −1.0000 |
| S15 | Spherical | Infinity | 0.1100 | 1.519 | 64.17 | |
| S16 | Spherical | Infinity | 0.0923 | | | |
| S17 | Spherical | Infinity | | | | |

Table 6 shows high-order term coefficients that can be used for each aspheric mirror surface in Example 3, wherein a surface type of each aspheric surface may be defined by the formula (1) provided in Example 1 above.

TABLE 6

| Surface number | A4 | A6 | A8 | A10 | A12 | A14 | A16 |
|---|---|---|---|---|---|---|---|
| S1 | 1.0229E−02 | −2.6623E−03 | −2.6984E−03 | −1.0640E−03 | −4.0701E−04 | −8.0825E−05 | −8.8919E−06 |
| S2 | −1.8852E−02 | 2.5660E−03 | −2.1541E−03 | −2.4228E−04 | −2.0556E−04 | −4.0601E−05 | −3.0992E−05 |
| S3 | 5.4119E−02 | 1.8508E−02 | 2.4933E−03 | 8.4877E−04 | 6.8268E−05 | 1.7673E−05 | −2.3205E−05 |
| S4 | 6.4019E−02 | 1.1716E−02 | 2.4705E−03 | 6.9961E−04 | 1.7063E−04 | 5.2288E−05 | 7.4591E−06 |
| S5 | −9.7642E−02 | 2.8412E−03 | 1.4152E−03 | −2.0792E−04 | −2.2428E−04 | 6.6651E−06 | 6.2722E−05 |
| S6 | −6.5115E−02 | 1.2101E−02 | 2.9749E−03 | 2.5289E−04 | −1.8462E−04 | 3.7302E−05 | −1.9116E−07 |
| S7 | −1.6322E−01 | 6.1452E−02 | 2.0175E−04 | −6.8234E−03 | −1.2346E−03 | 1.1356E−03 | −2.9448E−04 |
| S8 | −3.1671E−01 | 9.4475E−02 | 1.2015E−03 | −5.4086E−03 | −3.8550E−03 | 7.2891E−04 | −2.8531E−04 |
| S9 | −1.2512E+00 | 2.6921E−02 | 6.2640E−03 | 8.4808E−03 | 3.2875E−03 | 8.3742E−03 | 3.0045E−03 |
| S10 | −1.2410E+00 | 1.4689E−01 | −1.0002E−03 | −1.6287E−02 | −4.6673E−03 | 7.7988E−03 | 4.9168E−04 |
| S11 | −2.6011E+00 | 5.7659E−01 | 3.6533E−03 | −5.6159E−02 | 2.1870E−02 | −7.6086E−03 | −2.7055E−04 |
| S12 | −1.7430E+00 | 4.5267E−01 | −1.0659E−01 | 4.8508E−02 | 2.7123E−02 | −2.1326E−02 | 9.6748E−03 |
| S13 | 8.4970E−01 | 7.5816E−01 | −5.0759E−01 | 2.9601E−01 | −1.6850E−01 | 8.6638E−02 | −5.6704E−02 |
| S14 | −6.5143E+00 | 1.7744E+00 | −4.4215E−01 | 1.3737E−01 | −1.6503E−01 | 1.0993E−01 | −6.4553E−02 |
| Surface number | A18 | A20 | A22 | A24 | A26 | A28 | A30 |
| S1 | 2.4939E−06 | −1.9689E−06 | 6.8241E−07 | −3.6060E−08 | −4.7723E−07 | 1.9274E−10 | 0.0000E+00 |
| S2 | 9.2319E−06 | −8.2862E−06 | 4.3399E−06 | −8.8487E−09 | 0.0000E+00 | 0.0000E+00 | 0.0000E+00 |
| S3 | 7.8537E−06 | −4.4382E−06 | 2.6947E−07 | 0.0000E+00 | 0.0000E+00 | 0.0000E+00 | 0.0000E+00 |
| S4 | 1.4856E−06 | −2.0320E−06 | −8.0993E−08 | 0.0000E+00 | 0.0000E+00 | 0.0000E+00 | 0.0000E+00 |
| S5 | 6.7383E−05 | 2.5194E−05 | −7.6601E−06 | −2.1095E−05 | −1.1027E−05 | −4.3960E−06 | −1.5482E−07 |
| S6 | 2.0271E−05 | −4.6890E−06 | 5.8611E−06 | −4.8340E−06 | 2.0314E−06 | −1.5366E−06 | 5.4227E−07 |
| S7 | −3.0293E−04 | −1.1471E−04 | −1.3589E−05 | −5.0808E−05 | −2.4299E−05 | −8.9779E−06 | −2.8842E−06 |
| S8 | −9.6722E−05 | −2.9050E−05 | 6.5153E−06 | −3.1013E−05 | −7.4545E−06 | 1.5214E−05 | 1.3759E−05 |
| S9 | −1.3926E−03 | −1.8380E−03 | −7.0986E−04 | −5.5187E−05 | 7.5099E−05 | 9.4177E−05 | 6.6776E−05 |
| S10 | −2.0972E−03 | 9.7089E−05 | 9.7884E−04 | 1.3929E−04 | −2.1184E−04 | −1.5434E−06 | 1.1077E−04 |
| S11 | 3.4601E−03 | 4.5808E−04 | −1.8967E−03 | −2.1395E−05 | 6.2457E−04 | −4.6946E−05 | −8.2352E−05 |
| S12 | −3.3701E−03 | 1.2354E−03 | 1.6283E−03 | −1.8999E−04 | −4.2769E−04 | −2.4011E−04 | 2.0207E−04 |
| S13 | 3.5600E−02 | −1.7766E−02 | 4.9045E−03 | 1.8537E−03 | −3.0220E−03 | 1.8866E−03 | −4.3498E−04 |
| S14 | 1.8817E−02 | −8.6631E−03 | 9.5132E−03 | −3.1459E−03 | −1.1532E−03 | 5.1891E−04 | 3.0533E−04 |

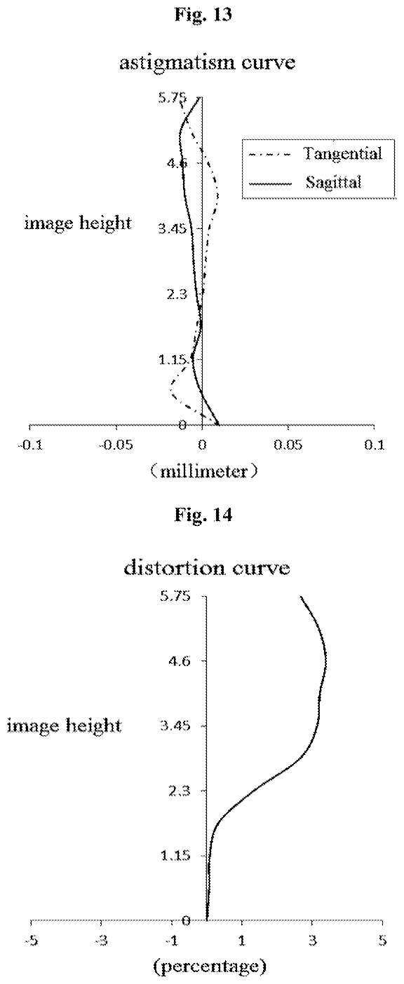

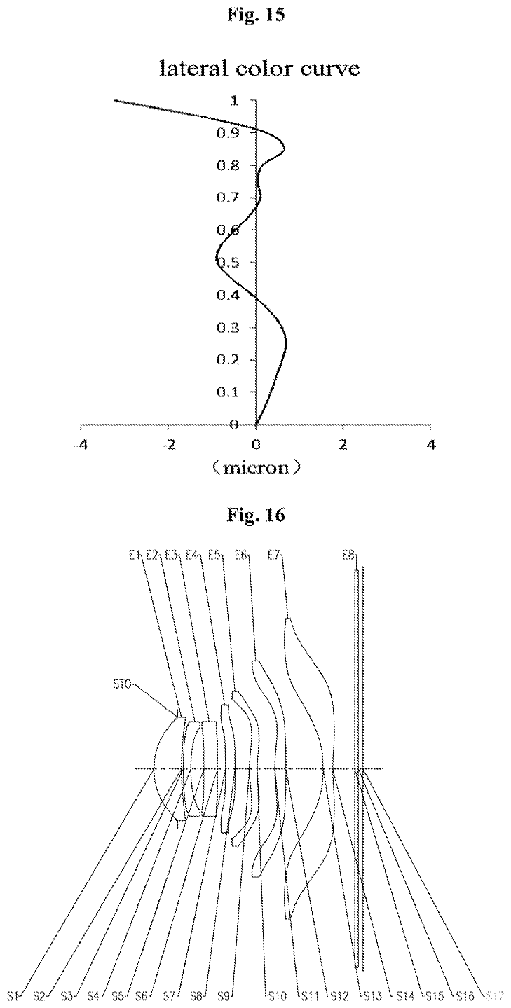

FIG. 12 shows a longitudinal aberration curve of the camera lens assembly of Example 3, which represents deviations of a convergence focal point after light with different wavelengths passes through the camera lens assembly. FIG. 13 shows an astigmatism curve of the camera lens assembly of Example 3, which represents a tangential image surface curvature and a sagittal image surface curvature. FIG. 14 shows a distortion curve of the camera lens assembly of Example 3, which represents distortion values corresponding to different fields of view. FIG. 15 shows a lateral color curve of the camera lens assembly of Example 3, which represents deviations of different image heights on the imaging surface after the light passes through the camera lens assembly.

According to FIGS. 12-15, it can be seen that the camera lens assembly provided in Example 3 may achieve good imaging quality.

### EXAMPLE 4

As shown in FIGS. 16-20, the camera lens assembly in Example 4 of the disclosure is described. In this example and the following examples, for the sake of brevity, some descriptions similar to Example 1 will be omitted. FIG. 16 shows a structural schematic diagram of a camera lens assembly in Example 4.

As shown in FIG. 16, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a negative refractive power, an object-side surface S5 of the third lens is a convex surface, and an image-side surface S6 of the third lens is a concave surface. The fourth lens E4 has a negative refractive power, an object-side surface S7 of the fourth lens is a concave surface, and an image-side surface S8 of the fourth lens is a concave surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a convex surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 5.96 mm, a maximum field of view FOV of the camera lens assembly is 84.9°, ImgH is a half of a diagonal length of an effective pixel region on the imaging surface S17, and ImgH is 5.75 mm.

Table 7 shows a basic structure parameter table of the camera lens assembly of Example 4, wherein the units of curvature radius, thickness/distance and focal length are all millimeters (mm).

TABLE 7

| | | | | Material | | |
|---|---|---|---|---|---|---|
| Surface | | | | Refractive | Abbe | Conic |
| number | Surface type | Curvature radius | Thickness | index | number | coefficient |
| OBJ | Spherical | Infinity | Infinity | | | |
| STO | Spherical | Infinity | −0.7422 | | | |
| S1 | Aspheric | 2.0439 | 0.8659 | 1.536 | 55.60 | 0.0000 |
| S2 | Aspheric | 7.7588 | 0.0555 | | | 0.0000 |
| S3 | Aspheric | 9.9114 | 0.2351 | 1.677 | 19.20 | 0.0000 |
| S4 | Aspheric | 4.6296 | 0.4080 | | | 0.0000 |
| S5 | Aspheric | 108.6157 | 0.4278 | 1.677 | 19.20 | 0.0000 |
| S6 | Aspheric | 57.6421 | 0.2506 | | | 0.0000 |
| S7 | Aspheric | −391.6471 | 0.3009 | 1.540 | 51.85 | 0.0000 |
| S8 | Aspheric | 196.4365 | 0.4486 | | | 0.0000 |
| S9 | Aspheric | 3.0507 | 0.2436 | 1.594 | 31.37 | 0.0000 |
| S10 | Aspheric | 2.9441 | 0.5529 | | | 0.0000 |
| S11 | Aspheric | 4.6170 | 0.3473 | 1.552 | 43.99 | 0.0000 |
| S12 | Aspheric | −26.5958 | 1.1643 | | | 0.0000 |
| S13 | Aspheric | −6.0094 | 0.3000 | 1.546 | 53.80 | 0.0000 |
| S14 | Aspheric | 3.8361 | 0.6918 | | | −1.0000 |
| S15 | Spherical | Infinity | 0.1100 | 1.519 | 64.17 | |
| S16 | Spherical | Infinity | 0.1476 | | | |
| S17 | Spherical | Infinity | | | | |

Table 8 shows high-order term coefficients that can be used for each aspheric mirror surface in Example 4, wherein a surface type of each aspheric surface may be defined by the formula (1) provided in Example 1 above.

TABLE 8

| Surface number | A4 | A6 | A8 | A10 | A12 | A14 | A16 |
|---|---|---|---|---|---|---|---|
| S1 | 5.2712E−03 | −6.1630E−03 | −4.4464E−03 | −1.7626E−03 | −5.6276E−04 | −1.1053E−04 | −1.5602E−05 |
| S2 | −3.6618E−02 | 6.2832E−03 | −3.0871E−03 | 8.6800E−05 | −2.4320E−04 | −5.5446E−05 | −1.9241E−05 |
| S3 | 6.0062E−02 | 2.3557E−02 | 2.0848E−03 | 1.4496E−03 | 4.3351E−05 | 4.5921E−06 | −1.2801E−05 |
| S4 | 8.2827E−02 | 1.5083E−02 | 3.0671E−03 | 1.2004E−03 | 2.8594E−04 | 8.9249E−05 | 1.8584E−05 |
| S5 | −7.0220E−02 | 2.2341E−05 | 7.8412E−04 | 1.5103E−04 | 1.4446E−05 | −3.1474E−06 | 9.9376E−06 |
| S6 | −7.7776E−02 | 1.7659E−02 | 5.1243E−03 | 3.0450E−04 | −1.9009E−04 | 6.0854E−05 | 7.1198E−05 |
| S7 | −1.9968E−01 | 7.7931E−02 | 1.4163E−03 | −1.1069E−02 | −6.9672E−04 | 2.0515E−03 | −1.9094E−04 |
| S8 | −3.1695E−01 | 1.0554E−01 | −8.7876E−04 | −1.2562E−02 | −3.0352E−03 | 2.0586E−03 | −4.1263E−04 |
| S9 | −1.5390E+00 | 8.2098E−02 | −7.4965E−03 | 2.0080E−02 | −1.6752E−03 | 9.3165E−03 | 2.2641E−03 |
| S10 | −2.0629E+00 | 2.7339E−01 | −4.5854E−02 | −2.9610E−04 | −1.1314E−02 | 1.4364E−02 | 8.0855E−04 |
| S11 | −2.5763E+00 | 5.8082E−01 | −3.2083E−02 | −4.4185E−02 | 6.6089E−03 | 9.0971E−03 | −3.2012E−03 |
| S12 | −7.6611E−01 | 7.4889E−02 | 4.7660E−02 | −3.4184E−03 | 1.2426E−02 | −4.2049E−03 | −4.1023E−03 |
| S13 | 6.0009E−01 | 6.4014E−01 | −4.0855E−01 | 2.0332E−01 | −7.8050E−02 | 1.9165E−02 | −2.0439E−02 |
| S14 | −5.4397E+00 | 1.4175E+00 | −3.2975E−01 | 9.0730E−02 | −8.6380E−02 | 5.7509E−02 | −5.3177E−02 |
| Surface number | A18 | A20 | A22 | A24 | A26 | A28 | A30 |
| S1 | −4.1147E−07 | −9.1131E−06 | 0.0000E+00 | 0.0000E+00 | 0.0000E+00 | 0.0000E+00 | 0.0000E+00 |
| S2 | 5.5665E−06 | −5.2639E−06 | 8.1381E−07 | 0.0000E+00 | 0.0000E+00 | 0.0000E+00 | 0.0000E+00 |
| S3 | 8.8003E−07 | −1.3514E−06 | 0.0000E+00 | 0.0000E+00 | 0.0000E+00 | 0.0000E+00 | 0.0000E+00 |
| S4 | 6.5148E−06 | 1.9484E−06 | 0.0000E+00 | 0.0000E+00 | 0.0000E+00 | 0.0000E+00 | 0.0000E+00 |
| S5 | −4.2920E−06 | −3.4336E−06 | −3.9977E−06 | −3.2235E−07 | 1.8393E−06 | 3.0294E−06 | 1.1834E−06 |
| S6 | 3.5871E−05 | −4.8305E−06 | −2.3435E−06 | −5.7272E−06 | −9.1076E−07 | −2.6638E−06 | −7.9393E−07 |
| S7 | −5.5702E−04 | −1.7089E−04 | 3.8180E−05 | −5.3031E−05 | −4.6281E−05 | −1.2158E−05 | 4.6161E−06 |
| S8 | −5.5949E−04 | −3.2503E−04 | 2.5275E−05 | 2.8659E−06 | 4.0190E−05 | 3.0784E−05 | 2.3308E−05 |
| S9 | −1.6073E−03 | −2.5956E−03 | −8.9496E−04 | 1.5289E−06 | 1.9099E−04 | 1.5285E−04 | 8.3567E−05 |
| S10 | −1.6512E−03 | −3.7941E−04 | 1.3481E−03 | 1.9304E−04 | −2.7282E−04 | −3.1643E−05 | 1.2786E−04 |
| S11 | −9.1962E−05 | −2.5886E−03 | 1.2025E−03 | 1.5806E−03 | −8.5997E−04 | −4.3096E−05 | 2.9520E−04 |
| S12 | 2.9062E−03 | −1.7609E−03 | −5.0730E−04 | 4.3549E−05 | −9.4392E−04 | 7.8697E−04 | 3.7007E−04 |
| S13 | 2.2206E−02 | −1.6649E−02 | 1.0249E−02 | −5.0959E−03 | 1.9993E−03 | −5.0332E−04 | 1.4618E−04 |
| S14 | 1.7901E−02 | −4.9759E−03 | 1.2476E−02 | −6.0470E−03 | 1.3000E−04 | −9.1428E−04 | 1.4357E−03 |

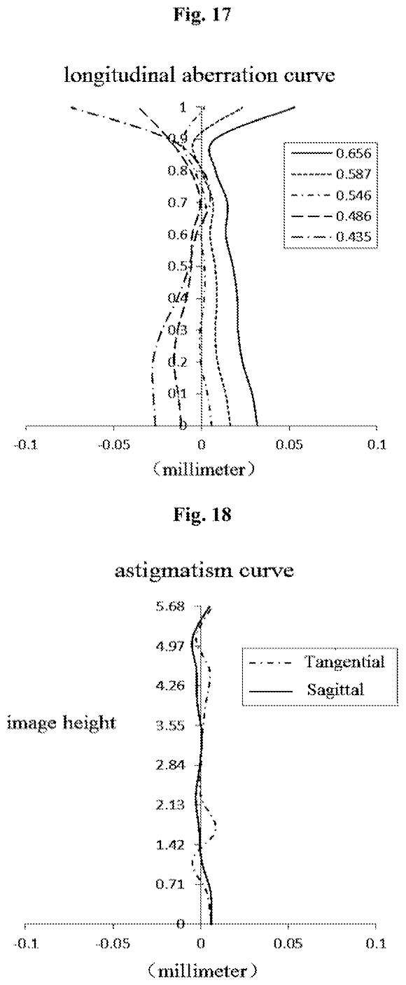

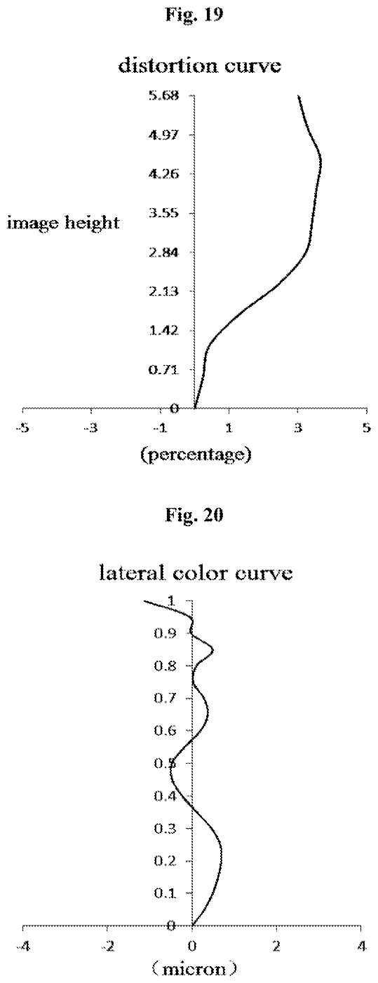

FIG. 17 shows a longitudinal aberration curve of the camera lens assembly of Example 4, which represents deviations of a convergence focal point after light with different wavelengths passes through the camera lens assembly. FIG. 18 shows an astigmatism curve of the camera lens assembly of Example 4, which represents a tangential image surface curvature and a sagittal image surface curvature. FIG. 19 shows a distortion curve of the camera lens assembly of Example 4, which represents distortion values corresponding to different fields of view. FIG. 20 shows a lateral color curve of the camera lens assembly of Example 4, which represents deviations of different image heights on the imaging surface after the light passes through the camera lens assembly.

According to FIGS. 17-20, it can be seen that the camera lens assembly provided in Example 4 may achieve good imaging quality.

### EXAMPLE 5

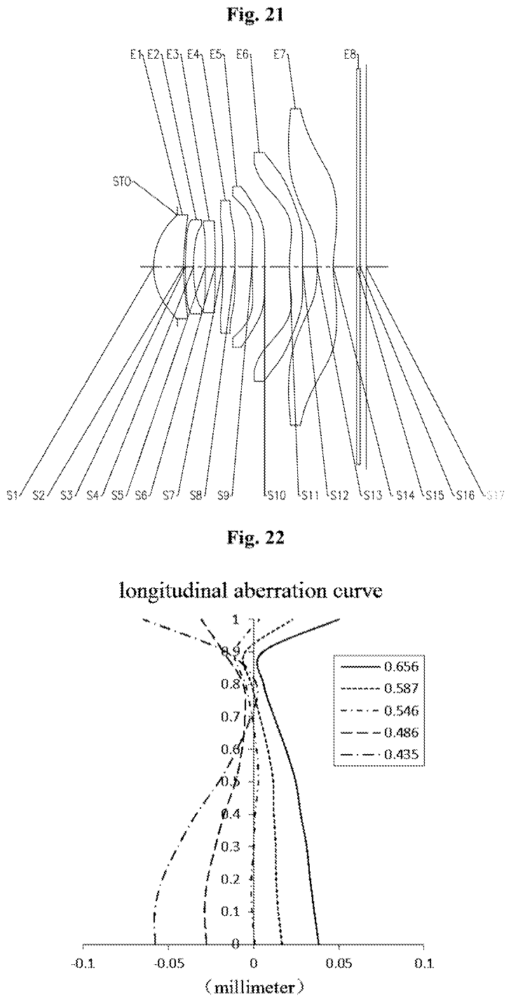

As shown in FIGS. 21-25, the camera lens assembly in Example 5 of the disclosure is described. In this example and the following examples, for the sake of brevity, some descriptions similar to Example 1 will be omitted. FIG. 21 shows a structural schematic diagram of a camera lens assembly in Example 5.

As shown in FIG. 21, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a negative refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a concave surface. The fifth lens E5 has a positive refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 5.96 mm, a maximum field of view FOV of the camera lens assembly is 84.9°, ImgH is a half of a diagonal length of an effective pixel region on the imaging surface S17, and ImgH is 5.68 mm.

Table 9 shows a basic structure parameter table of the camera lens assembly of Example 5, wherein the units of curvature radius, thickness/distance and focal length are all millimeters (mm).

TABLE 9

| | | | | Material | | |
|---|---|---|---|---|---|---|
| Surface | | | | Refractive | Abbe | Conic |
| number | Surface type | Curvature radius | Thickness | index | number | coefficient |
| OBJ | Spherical | Infinity | Infinity | | | |
| STO | Spherical | Infinity | −0.7402 | | | |
| S1 | Aspheric | 2.0491 | 0.9382 | 1.536 | 55.60 | 0.0000 |
| S2 | Aspheric | 5.7461 | 0.0556 | | | 0.0000 |
| S3 | Aspheric | 8.8624 | 0.2544 | 1.677 | 19.20 | 0.0000 |
| S4 | Aspheric | 5.3193 | 0.3676 | | | 0.0000 |
| S5 | Aspheric | 42.0087 | 0.3059 | 1.677 | 19.20 | 0.0000 |
| S6 | Aspheric | 30.9460 | 0.2360 | | | 0.0000 |
| S7 | Aspheric | 29.0619 | 0.3870 | 1.536 | 55.60 | 0.0000 |
| S8 | Aspheric | 37.7271 | 0.5325 | | | 0.0000 |
| S9 | Aspheric | 8.3533 | 0.3945 | 1.596 | 31.02 | 0.0000 |
| S10 | Aspheric | 24.0836 | 0.7758 | | | 0.0000 |
| S11 | Aspheric | 5.3395 | 0.4083 | 1.556 | 41.63 | 0.0000 |
| S12 | Aspheric | 372.1431 | 0.4582 | | | 0.0000 |
| S13 | Aspheric | −9.4226 | 0.5000 | 1.551 | 44.44 | 0.0000 |
| S14 | Aspheric | 2.8530 | 0.7344 | | | −1.0000 |
| S15 | Spherical | Infinity | 0.1100 | 1.519 | 64.17 | |
| S16 | Spherical | Infinity | 0.1916 | | | |
| S17 | Spherical | Infinity | | | | |

Table 10 shows high-order term coefficients that can be used for each aspheric mirror surface in Example 5, wherein a surface type of each aspheric surface may be defined by the formula (1) provided in Example 1 above.

TABLE 10

| Surface number | A4 | A6 | A8 | A10 | A12 | A14 | A16 |
|---|---|---|---|---|---|---|---|
| S1 | 4.2976E−03 | −4.2293E−03 | −2.9959E−03 | −1.1477E−03 | −3.3579E−04 | −6.7582E−05 | −9.6785E−06 |
| S2 | −8.5308E−02 | 1.4615E−02 | −3.4839E−03 | −3.8749E−04 | −2.9834E−04 | −1.6073E−04 | −8.3988E−06 |
| S3 | 1.6115E−02 | 2.7328E−02 | 8.0451E−04 | 1.1661E−03 | 6.5810E−05 | −6.0720E−05 | −1.6205E−06 |
| S4 | 6.5388E−02 | 1.2996E−02 | 1.5096E−03 | 8.6843E−04 | 2.0885E−04 | 5.0596E−05 | 1.8868E−05 |
| S5 | −1.1151E−01 | 1.9737E−03 | 1.6871E−03 | 3.0273E−04 | −2.4592E−04 | −1.3858E−04 | −1.7924E−05 |
| S6 | −6.9740E−02 | 1.1910E−02 | 2.6900E−03 | 5.2456E−04 | −3.1384E−05 | 1.6504E−05 | 9.9157E−06 |
| S7 | −1.6256E−01 | 5.7759E−02 | −2.6752E−03 | −5.0842E−03 | −5.0892E−04 | 6.3771E−04 | −2.0647E−04 |
| S8 | −2.8480E−01 | 8.1086E−02 | 2.3048E−03 | −6.2678E−03 | −2.2205E−03 | 5.7600E−04 | −5.7351E−05 |
| S9 | −8.9621E−01 | −1.4661E−02 | 1.4332E−02 | 7.3902E−03 | 5.1781E−03 | 6.7651E−03 | 2.8053E−03 |
| S10 | −9.5939E−01 | 1.3181E−01 | −4.3230E−04 | −1.8371E−02 | −2.3435E−03 | 6.8074E−03 | 7.3026E−04 |
| S11 | −2.7460E+00 | 6.5584E−01 | −2.7430E−02 | −6.5138E−02 | 2.5290E−02 | −7.4687E−03 | 4.8369E−03 |
| S12 | −1.4990E+00 | 2.7429E−01 | −7.5429E−02 | 4.7916E−02 | 1.7351E−02 | −2.2245E−02 | 1.4757E−02 |
| S13 | 1.2690E−01 | 5.6347E−01 | −4.1196E−01 | 2.4817E−01 | −1.4476E−01 | 6.7315E−02 | −3.7741E−02 |
| S14 | −6.7209E+00 | 1.7713E+00 | −5.0961E−01 | 1.3907E−01 | −9.9054E−02 | 5.9834E−02 | −5.7676E−02 |
| Surface number | A18 | A20 | A22 | A24 | A26 | A28 | A30 |
| S1 | 1.1901E−06 | −1.9781E−06 | 6.7108E−07 | −4.0178E−08 | −4.7914E−07 | 1.3868E−09 | 0.0000E+00 |
| S2 | −8.9168E−07 | −3.5981E−06 | 5.5514E−06 | −1.0764E−09 | 0.0000E+00 | 0.0000E+00 | 0.0000E+00 |
| S3 | −5.1395E−06 | −3.7658E−06 | 2.8148E−07 | 0.0000E+00 | 0.0000E+00 | 0.0000E+00 | 0.0000E+00 |
| S4 | 1.4404E−06 | −2.2469E−06 | −7.4169E−08 | 0.0000E+00 | 0.0000E+00 | 0.0000E+00 | 0.0000E+00 |
| S5 | 4.7836E−05 | 5.9628E−05 | 3.1276E−05 | 6.9956E−07 | −1.7821E−05 | −1.4798E−05 | −7.4441E−06 |
| S6 | 5.4349E−06 | 1.1888E−06 | −3.2016E−06 | 1.3736E−07 | −1.0719E−06 | 3.7963E−07 | 5.4231E−07 |
| S7 | −2.8245E−04 | −1.2742E−04 | −6.8620E−05 | −4.8262E−05 | −3.6375E−05 | −1.4080E−05 | −6.3285E−06 |
| S8 | −2.6524E−04 | −1.8622E−04 | −8.0649E−05 | −1.3365E−05 | 1.2256E−05 | 2.0021E−05 | 9.4693E−06 |
| S9 | −8.6326E−04 | −1.2920E−03 | −6.9672E−04 | −1.9672E−04 | −3.0466E−05 | 1.8871E−05 | 1.4544E−05 |
| S10 | −1.9629E−03 | 1.3709E−04 | 7.2404E−04 | 1.0055E−04 | −1.6684E−04 | −1.8442E−05 | 6.4063E−05 |
| S11 | −5.4607E−04 | −6.5603E−04 | −6.7631E−04 | 6.0846E−04 | 2.3620E−04 | −3.4833E−04 | 7.1391E−05 |
| S12 | −1.0001E−02 | 5.2615E−03 | 3.8294E−04 | −2.0952E−04 | −3.9420E−04 | −2.2663E−04 | 2.1522E−04 |
| S13 | 2.1159E−02 | −6.9484E−03 | 2.8863E−04 | 2.8920E−03 | −2.3134E−03 | 1.2628E−03 | −3.8449E−04 |
| S14 | 2.9021E−02 | −3.6461E−03 | 7.2107E−03 | −5.5532E−03 | 1.6865E−03 | 1.7026E−04 | 7.4329E−05 |

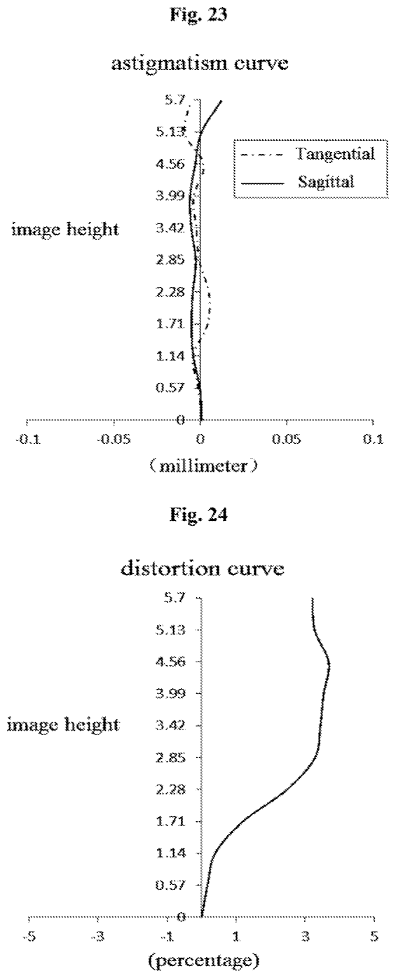

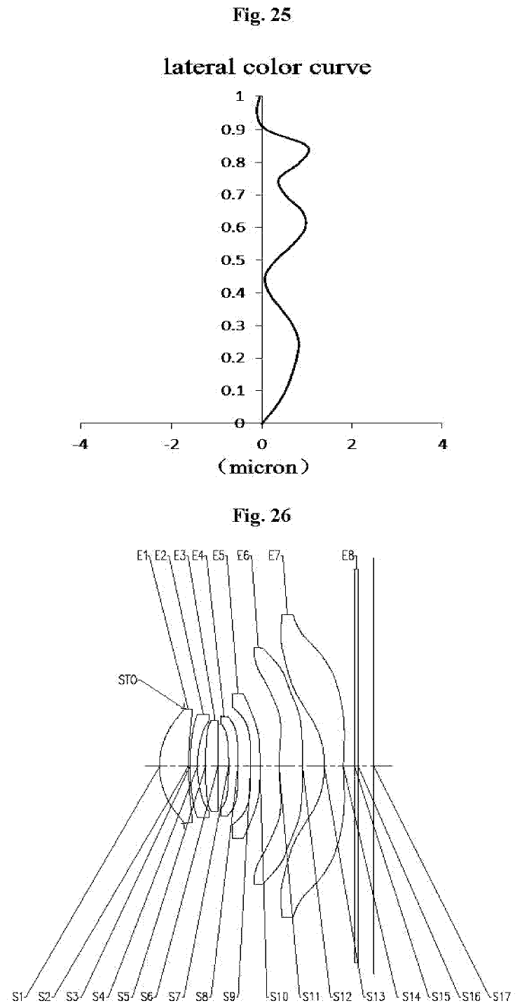

FIG. 22 shows a longitudinal aberration curve of the camera lens assembly of Example 5, which represents deviations of a convergence focal point after light with different wavelengths passes through the camera lens assembly. FIG. 23 shows an astigmatism curve of the camera lens assembly of Example 5, which represents a tangential image surface curvature and a sagittal image surface curvature. FIG. 24 shows a distortion curve of the camera lens assembly of Example 5, which represents distortion values corresponding to different fields of view. FIG. 25 shows a lateral color curve of the camera lens assembly of Example 5, which represents deviations of different image heights on the imaging surface after the light passes through the camera lens assembly.

According to FIGS. 22-25, it can be seen that the camera lens assembly provided in Example 5 may achieve good imaging quality.

### EXAMPLE 6

As shown in FIGS. 26-30, the camera lens assembly in Example 6 of the disclosure is described. In this example and the following examples, for the sake of brevity, some descriptions similar to Example 1 will be omitted. FIG. 26 shows a structural schematic diagram of a camera lens assembly in Example 6.

As shown in FIG. 26, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a negative refractive power, an object-side surface S7 of the fourth lens is a concave surface, and an image-side surface S8 of the fourth lens is a convex surface. The fifth lens E5 has a positive refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a convex surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.15 mm, a maximum field of view FOV of the camera lens assembly is 88.4°, ImgH is a half of a diagonal length of an effective pixel region on the imaging surface S17, and ImgH is 5.69 mm.

Table 11 shows a basic structure parameter table of the camera lens assembly of Example 6, wherein the units of curvature radius, thickness/distance and focal length are all millimeters (mm).

TABLE 11

| | | | | Material | | Conic |
|---|---|---|---|---|---|---|
| Surface | Surface | Curvature | Thick- | Refractive | Abbe | coeffi- |
| number | type | radius | ness | index | number | cient |
| OBJ | Spherical | Infinity | Infinity | | | |
| STO | Spherical | Infinity | −0.7500 | | | |
| S1 | Aspheric | 2.1274 | 0.9090 | 1.546 | 56.09 | 0.0000 |
| S2 | Aspheric | 8.7088 | 0.0457 | | | 0.0000 |
| S3 | Aspheric | 5.9549 | 0.2330 | 1.679 | 19.24 | 0.0000 |
| S4 | Aspheric | 3.4028 | 0.2531 | | | 0.0000 |
| S5 | Aspheric | 11 6364 | 0.3840 | 1.571 | 37.40 | 0.0000 |
| S6 | Aspheric | 52.6847 | 0.3318 | | | 0.0000 |
| S7 | Aspheric | −26.8565 | 0.2951 | 1.679 | 19.24 | 0.0000 |
| S8 | Aspheric | −121.5297 | 0.3968 | | | 0.0000 |
| S9 | Aspheric | 77.6435 | 0.2900 | 1.620 | 25.93 | 0.0000 |
| S10 | Aspheric | 99.5893 | 0.5981 | | | 0.0000 |
| S11 | Aspheric | 5.5904 | 0.7333 | 1.546 | 56.09 | 0.0000 |
| S12 | Aspheric | −29.6486 | 0.6802 | | | 0.0000 |
| S13 | Aspheric | −3.9844 | 0.5943 | 1.546 | 56.09 | −1.0000 |
| S14 | Aspheric | 4.8084 | 0.3540 | | | 0.0000 |
| S15 | Spherical | Infinity | 0.1100 | 1.519 | 64.17 | |
| S16 | Spherical | Infinity | 0.4915 | | | |
| S17 | Spherical | Infinity | | | | |

Table 12 shows high-order term coefficients that can be used for each aspheric mirror surface in Example 6, wherein a surface type of each aspheric surface may be defined by the formula (1) provided in Example 1 above.

TABLE 12

| Surface number | A4 | A6 | A8 | A10 | A12 | A14 | A16 |
|---|---|---|---|---|---|---|---|
| S1 | −6.1126E−02 | −2.5378E−02 | −8.3720E−03 | −1.7640E−03 | −9.2261E−05 | 1.6650E−04 | 8.1418E−05 |
| S2 | −4.4874E−02 | 6.1075E−03 | −2.8447E−03 | 1.9407E−03 | −1.8484E−04 | 2.6823E−04 | −1.3186E−05 |
| S3 | 1.1039E−02 | 1.8128E−02 | −3.2509E−03 | 1.1661E−03 | −4.6960E−04 | 1.2321E−04 | −3.7676E−05 |
| S4 | 6.5330E−02 | 1.3248E−02 | −2.3391E−03 | −1.7334E−03 | −1.3388E−03 | −5.0358E−04 | −1.5216E−04 |
| S5 | 6.8561E−02 | 2.6968E−02 | 7.1762E−03 | 1.2637E−03 | −7.6689E−05 | −2.0432E−04 | −1.0493E−04 |
| S6 | −4.1458E−03 | 6.1517E−03 | 1.9504E−03 | 6.2704E−04 | 1.6526E−04 | 6.1937E−05 | 9.8749E−06 |
| S7 | −1.9637E−01 | −1.9721E−02 | −3.8760E−03 | −7.1666E−04 | −3.2257E−04 | −1.0392E−04 | −6.9859E−05 |
| S8 | −3.0104E−01 | −2.1031E−02 | 4.5055E−04 | 2.8228E−03 | 1.1365E−03 | 6.5001E−04 | 2.2078E−04 |
| S9 | −5.6387E−01 | −1.9349E−02 | −1.3013E−02 | 6.5228E−03 | 4.7989E−03 | 4.1903E−03 | 1.7607E−03 |
| S10 | −6.7266E−01 | 1.5136E−01 | −3.8197E−02 | 3.3466E−03 | 3.2074E−03 | 1.2104E−03 | −1.7641E−03 |
| S11 | −2.3420E+00 | 5.1775E−01 | −7.3155E−02 | 8.8920E−03 | 2.0168E−02 | −1.8559E−02 | −9.0862E−04 |
| S12 | −1.1537E+00 | 1.2618E−01 | −9.2824E−02 | 3.0017E−02 | 6.4065E−02 | −5.8468E−03 | −4.0355E−03 |
| S13 | 7.8150E−01 | 4.1116E−01 | −3.0582E−01 | 2.0552E−01 | −9.9369E−02 | 2.6151E−02 | −4.3493E−03 |
| S14 | −5.4894E+00 | 8.7039E−01 | −2.4571E−01 | 1.5934E−01 | −1.0812E−01 | 3.1430E−02 | −1.4176E−02 |
| Surface number | A18 | A20 | A22 | A24 | A26 | A28 | A30 |
| S1 | 2.9181E−05 | 2.9778E−06 | 2.4180E−06 | 0.0000E+00 | 0.0000E+00 | 0.0000E+00 | 0.0000E+00 |
| S2 | 4.1950E−05 | −5.0745E−07 | 5.6953E−06 | 0.0000E+00 | 0.0000E+00 | 0.0000E+00 | 0.0000E+00 |
| S3 | 5.7294E−06 | −1.2284E−05 | −6.0352E−06 | 0.0000E+00 | 0.0000E+00 | 0.0000E+00 | 0.0000E+00 |
| S4 | −8.2058E−06 | 1.1838E−05 | 2.4111E−06 | −4.9530E−07 | 0.0000E+00 | 0.0000E+00 | 0.0000E+00 |
| S5 | −5.1487E−05 | −2.0411E−05 | −2.2136E−05 | −1.6206E−05 | −1.1257E−05 | 0.0000E+00 | 0.0000E+00 |
| S6 | 8.0546E−06 | −3.7387E−06 | −3.5459E−06 | −3.7433E−06 | 0.0000E+00 | 0.0000E+00 | 0.0000E+00 |
| S7 | −4.4759E−05 | −3.1218E−05 | −1.8866E−05 | −8.4854E−06 | −2.5887E−06 | 0.0000E+00 | 0.0000E+00 |
| S8 | 5.6567E−05 | −1.3603E−05 | −1.8171E−05 | −9.8884E−06 | −4.1515E−06 | 0.0000E+00 | 0.0000E+00 |
| S9 | 2.0445E−04 | −4.5392E−04 | −4.5391E−04 | −2.3932E−04 | −6.4396E−05 | 1.5569E−05 | 1.0235E−05 |
| S10 | −5.9851E−05 | 3.7063E−04 | 5.1180E−05 | −1.4058E−04 | −2.4949E−05 | 2.1407E−05 | 0.0000E+00 |
| S11 | 5.5974E−03 | −1.3628E−03 | −6.8295E−04 | 1.9587E−04 | 5.6427E−05 | 2.8049E−05 | −2.0551E−05 |
| S12 | −1.3369E−03 | −4.9310E−03 | −6.9168E−04 | 4.1025E−04 | 2.3103E−04 | 2.5370E−04 | −3.0193E−05 |
| S13 | 4.8522E−03 | −6.2724E−03 | 3.6751E−03 | −1.9014E−03 | 1.3895E−03 | −7.7530E−04 | 1.8343E−04 |
| S14 | 9.6983E−03 | −7.8431E−03 | 1.2272E−03 | −2.2243E−03 | 2.2824E−03 | −5.1996E−04 | 8.9085E−05 |

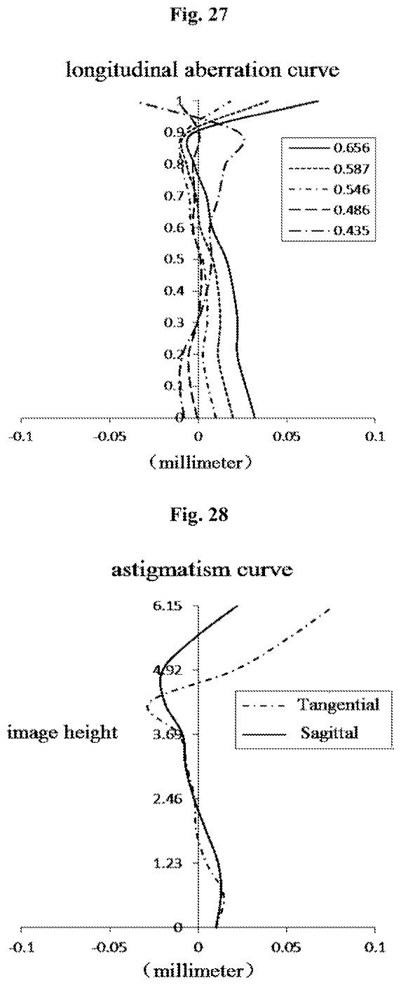

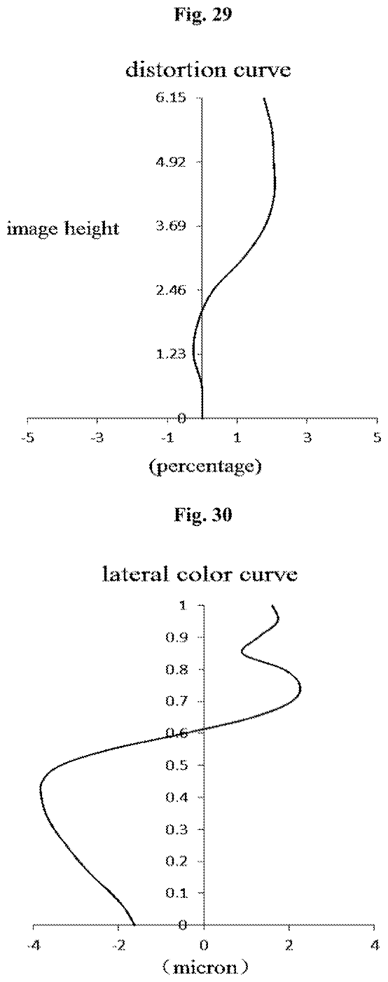

FIG. 27 shows a longitudinal aberration curve of the camera lens assembly of Example 6, which represents deviations of a convergence focal point after light with different wavelengths passes through the camera lens assembly. FIG. 28 shows an astigmatism curve of the camera lens assembly of Example 6, which represents a tangential image surface curvature and a sagittal image surface curvature. FIG. 29 shows a distortion curve of the camera lens assembly of Example 6, which represents distortion values corresponding to different fields of view. FIG. 30 shows a lateral color curve of the camera lens assembly of Example 6, which represents deviations of different image heights on the imaging surface after the light passes through the camera lens assembly.

According to FIGS. 27-30, it can be seen that the camera lens assembly provided in Example 6 may achieve good imaging quality.

### EXAMPLE 7

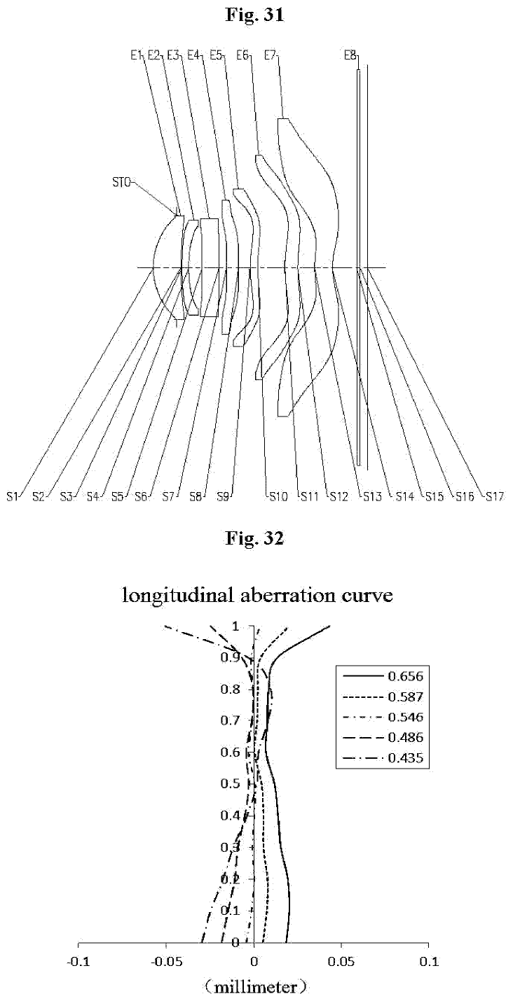

As shown in FIGS. 31-35, the camera lens assembly in Example 7 of the disclosure is described. In this example and the following examples, for the sake of brevity, some descriptions similar to Example 1 will be omitted. FIG. 31 shows a structural schematic diagram of a camera lens assembly in Example 7.

As shown in FIG. 31, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a negative refractive power, an object-side surface S5 of the third lens is a convex surface, and an image-side surface S6 of the third lens is a concave surface. The fourth lens E4 has a positive refractive power, an object-side surface S7 of the fourth lens is a concave surface, and an image-side surface S8 of the fourth lens is a convex surface. The fifth lens E5 has a positive refractive power, an object-side surface S9 of the fifth lens is a convex surface, and an image-side surface S10 of the fifth lens is a concave surface. The sixth lens E6 has a negative refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 5.96 mm, a maximum field of view FOV of the camera lens assembly is 84.9°, ImgH is a half of a diagonal length of an effective pixel region on the imaging surface S17, and ImgH is 5.70 mm.

Table 13 shows a basic structure parameter table of the camera lens assembly of Example 7, wherein the units of curvature radius, thickness/distance and focal length are all millimeters (mm).

TABLE 13

| | | | | Material | | Conic |
|---|---|---|---|---|---|---|
| Surface | Surface | Curvature | Thick- | Refractive | Abbe | coeffi- |
| number | type | radius | ness | index | number | cient |
| OBJ | Spherical | Infinity | Infinity | | | |
| STO | Spherical | Infinity | −0.7304 | | | |
| S1 | Aspheric | 2.0696 | 0.8638 | 1.536 | 55.60 | 0.0000 |
| S2 | Aspheric | 8.7476 | 0.0347 | | | 0.0000 |
| S3 | Aspheric | 7.2946 | 0.2085 | 1.677 | 19.20 | 0.0000 |
| S4 | Aspheric | 3.9635 | 0.4240 | | | 0.0000 |
| S5 | Aspheric | 137.0316 | 0.5245 | 1.677 | 19.20 | 0.0000 |
| S6 | Aspheric | 40.6988 | 0.2410 | | | 0.0000 |
| S7 | Aspheric | −31.4560 | 0.3779 | 1.536 | 55.60 | 0.0000 |
| S8 | Aspheric | −23.2390 | 0.3558 | | | 0.0000 |
| S9 | Aspheric | 3.5787 | 0.2407 | 1.591 | 32.25 | 0.0000 |
| S10 | Aspheric | 4.6926 | 0.8464 | | | 0.0000 |
| S11 | Aspheric | 3.9101 | 0.4000 | 1.556 | 46.34 | 0.0000 |
| S12 | Aspheric | 3.7147 | 0.5291 | | | 0.0000 |
| S13 | Aspheric | 2.4221 | 0.5475 | 1.536 | 55.17 | −1.0000 |
| S14 | Aspheric | 1.4436 | 0.7705 | | | −1.0000 |
| S15 | Spherical | Infinity | 0.1100 | 1.519 | 64.17 | |
| S16 | Spherical | Infinity | 0.2257 | | | |
| S17 | Spherical | Infinity | | | | |

Table 14 shows high-order term coefficients that can be used for each aspheric mirror surface in Example 7, wherein a surface type of each aspheric surface may be defined by the formula (1) provided in Example 1 above.

TABLE 14

| Surface number | A4 | A6 | A8 | A10 | A12 | A14 | A16 |
|---|---|---|---|---|---|---|---|
| S1 | 5.8634E−03 | −6.1308E−03 | −4.2798E−03 | −1.6656E−03 | −5.1934E−04 | −1.0667E−04 | −2.5451E−05 |
| S2 | −3.0609E−02 | 7.8259E−03 | −4.5626E−03 | 8.7500E−04 | −5.2395E−04 | 6.2288E−05 | −4.7550E−05 |
| S3 | 4.7588E−02 | 2.6648E−02 | 7.9066E−04 | 1.9432E−03 | −2.1173E−04 | 7.6467E−05 | −3.7439E−05 |
| S4 | 7.0929E−02 | 1.6914E−02 | 3.2870E−03 | 1.3211E−03 | 2.4700E−04 | 8.1774E−05 | 2.7538E−06 |
| S5 | −7.1200E−02 | 3.5640E−05 | 8.3814E−04 | 1.7579E−04 | −3.4461E−05 | −2.2867E−05 | −1.1665E−05 |
| S6 | −7.4378E−02 | 1.5040E−02 | 5.9114E−03 | 5.5096E−04 | −2.2228E−04 | −3.5126E−05 | 6.8810E−05 |
| S7 | −1.4373E−01 | 6.2072E−02 | 7.2348E−03 | −1.1272E−02 | −2.1056E−03 | 2.0308E−03 | 3.4478E−04 |
| S8 | −2.7136E−01 | 9.2765E−02 | 4.5684E−03 | −1.3255E−02 | −4.4190E−03 | 1.8295E−03 | 5.1860E−04 |
| S9 | −1.2763E+00 | 5.0656E−03 | 2.7418E−02 | 8.4306E−03 | 2.6754E−03 | 6.6032E−03 | 3.0941E−03 |
| S10 | −1.3078E+00 | 1.4085E−01 | 1.2980E−02 | −2.3165E−02 | −7.0221E−04 | 1.0105E−02 | 1.6555E−03 |
| S11 | −3.2983E+00 | 6.1522E−01 | 3.8655E−05 | −6.6708E−02 | 6.8077E−03 | 1.0462E−02 | −1.3773E−04 |
| S12 | −3.8868E+00 | 5.9134E−01 | −1.6685E−01 | 3.1054E−02 | 2.6114E−02 | −3.4934E−03 | −1.1996E−02 |
| S13 | −7.0833E+00 | 2.5174E+00 | −1.1768E+00 | 5.6588E−01 | −2.5462E−01 | 8.2325E−02 | −2.0733E−02 |
| S14 | −1.1392E+01 | 2.8170E+00 | −9.0409E−01 | 3.4026E−01 | −2.3583E−01 | 1.2148E−01 | −6.9615E−02 |
| Surface number | A18 | A20 | A22 | A24 | A26 | A28 | A30 |
| S1 | −9.2140E−06 | −1.1553E−05 | 0.0000E+00 | 0.0000E+00 | 0.0000E+00 | 0.0000E+00 | 0.0000E+00 |
| S2 | 1.1097E−05 | −6.3696E−06 | −3.8972E−07 | 0.0000E+00 | 0.0000E+00 | 0.0000E+00 | 0.0000E+00 |
| S3 | 4.9286E−06 | −7.4443E−07 | 0.0000E+00 | 0.0000E+00 | 0.0000E+00 | 0.0000E+00 | 0.0000E+00 |
| S4 | −2.6787E−06 | −2.3073E−06 | 0.0000E+00 | 0.0000E+00 | 0.0000E+00 | 0.0000E+00 | 0.0000E+00 |
| S5 | −7.2836E−06 | −3.2165E−06 | 5.0379E−06 | 6.5179E−06 | 8.1888E−06 | 5.4591E−06 | 2.8991E−06 |
| S6 | 3.5911E−05 | 7.2430E−06 | −6.1704E−06 | −3.0265E−06 | −1.2749E−06 | 1.3320E−06 | 7.2302E−08 |
| S7 | −6.8956E−04 | −2.6432E−04 | 6.6317E−05 | 3.4897E−05 | −4.1761E−05 | −2.5965E−05 | 9.2919E−07 |
| S8 | −6.4012E−04 | −4.0511E−04 | −2.0108E−05 | 5.4481E−05 | 2.0500E−05 | −3.2916E−06 | 1.0102E−05 |
| S9 | −1.8567E−03 | −2.4485E−03 | −9.8297E−04 | 4.3428E−05 | 2.6198E−04 | 1.9141E−04 | 9.0376E−05 |
| S10 | −2.3853E−03 | 3.6973E−04 | 1.1418E−03 | 1.6346E−04 | −2.2647E−04 | 3.6652E−05 | 9.1801E−05 |
| S11 | −2.4341E−03 | −2.6454E−03 | 2.0107E−03 | 9.6408E−04 | −6.8248E−04 | 1.0925E−05 | 1.5234E−04 |
| S12 | 4.9294E−03 | −3.7101E−03 | 1.4938E−03 | 4.0621E−04 | −1.1907E−03 | −1.9445E−04 | 5.4237E−04 |
| S13 | 1.3219E−02 | −1.3843E−02 | 1.0320E−02 | −5.9266E−03 | 2.6266E−03 | −3.3091E−04 | −1.0473E−04 |
| S14 | 2.4362E−02 | −8.9966E−03 | 1.3016E−02 | −9.9429E−03 | 1.9598E−03 | −1.4202E−03 | 2.8815E−03 |

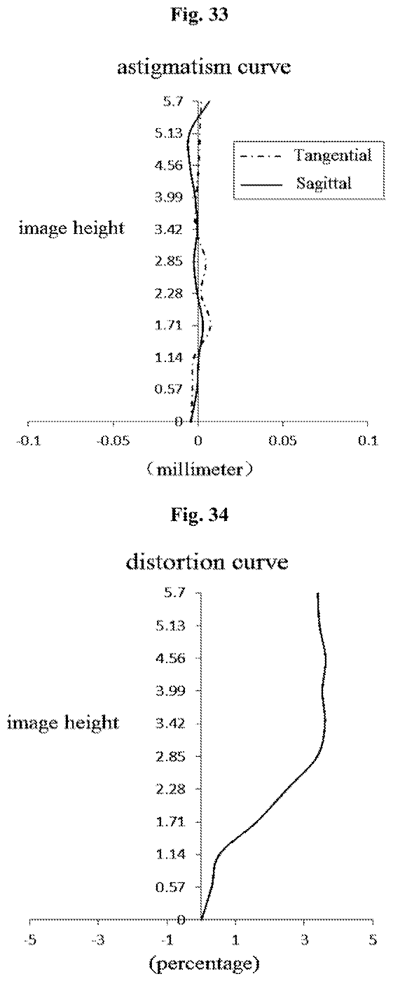

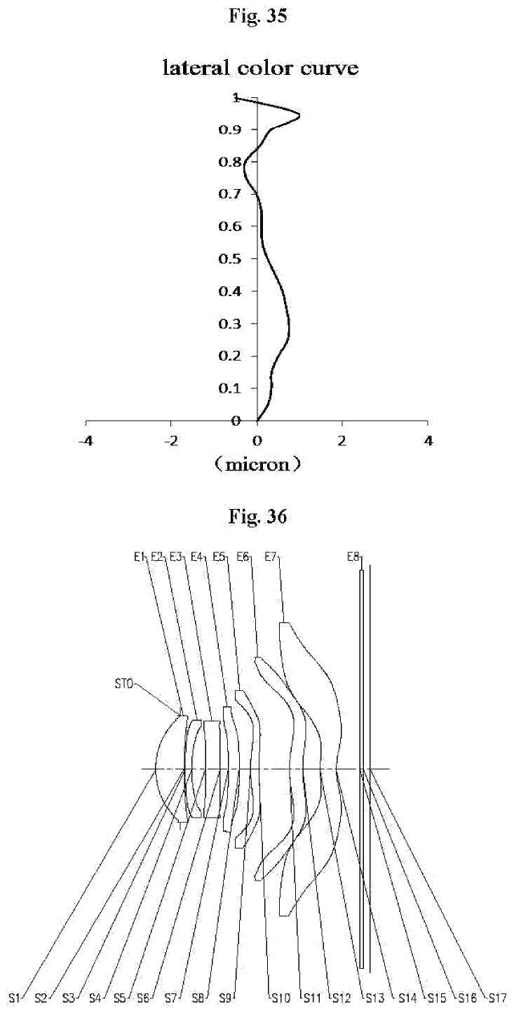

FIG. 32 shows a longitudinal aberration curve of the camera lens assembly of Example 7, which represents deviations of a convergence focal point after light with different wavelengths passes through the camera lens assembly. FIG. 33 shows an astigmatism curve of the camera lens assembly of Example 7, which represents a tangential image surface curvature and a sagittal image surface curvature. FIG. 34 shows a distortion curve of the camera lens assembly of Example 7, which represents distortion values corresponding to different fields of view. FIG. 35 shows a lateral color curve of the camera lens assembly of Example 7, which represents deviations of different image heights on the imaging surface after the light passes through the camera lens assembly.

According to FIGS. 32-35, it can be seen that the camera lens assembly provided in Example 7 may achieve good imaging quality.

### EXAMPLE 8

As shown in FIGS. 36-40, the camera lens assembly in Example 8 of the disclosure is described. In this example and the following examples, for the sake of brevity, some descriptions similar to Example 1 will be omitted. FIG. 36 shows a structural schematic diagram of a camera lens assembly in Example 8.

As shown in FIG. 36, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a negative refractive power, an object-side surface S5 of the third lens is a convex surface, and an image-side surface S6 of the third lens is a concave surface. The fourth lens E4 has a negative refractive power, an object-side surface S7 of the fourth lens is a concave surface, and an image-side surface S8 of the fourth lens is a convex surface. The fifth lens E5 has a positive refractive power, an object-side surface S9 of the fifth lens is a convex surface, and an image-side surface S10 of the fifth lens is a concave surface. The sixth lens E6 has a negative refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.10 mm, a maximum field of view FOV of the camera lens assembly is 84.9°, ImgH is a half of a diagonal length of an effective pixel region on the imaging surface S17, and ImgH is 5.73 mm.

Table 15 shows a basic structure parameter table of the camera lens assembly of Example 8, wherein the units of curvature radius, thickness/distance and focal length are all millimeters (mm).

TABLE 15

| | | | | Material | | Conic |
|---|---|---|---|---|---|---|
| Surface | Surface | Curvature | Thick- | Refractive | Abbe | coeffi- |
| number | type | radius | ness | index | number | cient |
| OBJ | Spherical | Infinity | Infinity | | | |
| STO | Spherical | Infinity | −0.7593 | | | |
| S1 | Aspheric | 2.0947 | 0.8841 | 1.536 | 55.60 | 0.0000 |
| S2 | Aspheric | 8.4159 | 0.0375 | | | 0.0000 |
| S3 | Aspheric | 7.9242 | 0.2076 | 1.677 | 19.20 | 0.0000 |
| S4 | Aspheric | 4.2516 | 0.4228 | | | 0.0000 |
| S5 | Aspheric | 60.1907 | 0.4635 | 1.677 | 19.20 | 0.0000 |
| S6 | Aspheric | 32.9491 | 0.2539 | | | 0.0000 |
| S7 | Aspheric | −33.8262 | 0.3421 | 1.539 | 53.05 | 0.0000 |
| S8 | Aspheric | −72.7902 | 0.3556 | | | 0.0000 |
| S9 | Aspheric | 3.6260 | 0.2563 | 1.587 | 33.34 | 0.0000 |
| S10 | Aspheric | 5.5511 | 0.9632 | | | 0.0000 |
| S11 | Aspheric | 3.3524 | 0.4097 | 1.551 | 50.06 | 0.0000 |
| S12 | Aspheric | 3.1682 | 0.5394 | | | −1.0000 |
| S13 | Aspheric | 2.5928 | 0.5000 | 1.536 | 55.60 | −1.0000 |
| S14 | Aspheric | 1.4048 | 0.7492 | | | −1.0000 |
| S15 | Spherical | Infinity | 0.1100 | 1.519 | 64.17 | |
| S16 | Spherical | Infinity | 0.2052 | | | |
| S17 | Spherical | Infinity | | | | |

Table 16 shows high-order term coefficients that can be used for each aspheric mirror surface in Example 8, wherein a surface type of each aspheric surface may be defined by the formula (1) provided in Example 1 above.

TABLE 16

| Surface number | A4 | A6 | A8 | A10 | A12 | A14 | A16 |
|---|---|---|---|---|---|---|---|
| S1 | 5.9169E−03 | −5.5120E−03 | −4.1320E−03 | −1.6490E−03 | −5.2869E−04 | −9.6071E−05 | −1.2723E−05 |
| S2 | −3.5436E−02 | 8.5908E−03 | −4.6127E−03 | 8.3176E−04 | −4.8326E−04 | 3.6338E−05 | −4.5857E−05 |
| S3 | 4.2168E−02 | 2.6247E−02 | 7.9863E−04 | 1.9781E−03 | −1.3856E−04 | 7.4173E−05 | −3.4198E−05 |
| S4 | 6.8330E−02 | 1.6253E−02 | 3.0987E−03 | 1.3324E−03 | 2.4285E−04 | 8.7560E−05 | 1.7973E−06 |
| S5 | −7.6215E−02 | 3.2034E−04 | 9.9760E−04 | 1.3071E−04 | −5.5302E−05 | −3.7588E−05 | −1.1066E−05 |
| S6 | −6.7349E−02 | 1.5823E−02 | 5.3165E−03 | 6.1835E−04 | −2.4320E−04 | −7.8305E−06 | 5.1410E−05 |
| S7 | −1.6529E−01 | 7.2157E−02 | 3.8359E−03 | −1.0950E−02 | −2.1563E−03 | 2.3171E−03 | 3.4416E−04 |
| S8 | −3.4630E−01 | 1.1220E−01 | 6.0592E−04 | −1.3064E−02 | −5.3143E−03 | 2.2290E−03 | 5.6428E−04 |
| S9 | −1.2508E+00 | 8.5527E−03 | 2.2583E−02 | 1.1438E−02 | 2.1882E−03 | 6.7217E−03 | 2.4851E−03 |
| S10 | −1.2124E+00 | 1.4414E−01 | 9.9817E−03 | −2.0439E−02 | −1.6550E−03 | 1.0241E−02 | 4.1496E−04 |
| S11 | −4.2371E+00 | 5.1301E−01 | −2.5115E−02 | −1.2107E−01 | −1.7937E−02 | 9.1557E−03 | −8.5420E−03 |
| S12 | −3.8578E+00 | 7.4459E−01 | −1.7574E−01 | 1.2599E−02 | 5.1907E−02 | 1.1147E−02 | −1.2127E−02 |
| S13 | −6.8406E+00 | 2.5341E+00 | −1.2424E+00 | 6.2242E−01 | −2.8075E−01 | 9.9602E−02 | −3.2655E−02 |
| S14 | −1.1761E+01 | 3.0215E+00 | −1.0018E+00 | 3.9838E−01 | −2.8454E−01 | 1.6003E−01 | −8.4778E−02 |
| Surface number | A18 | A20 | A22 | A24 | A26 | A28 | A30 |
| S1 | 1.3721E−07 | −1.1031E−05 | 0.0000E+00 | 0.0000E+00 | 0.0000E+00 | 0.0000E+00 | 0.0000E+00 |
| S2 | 1.3711E−05 | −8.8837E−06 | 5.6027E−07 | 0.0000E+00 | 0.0000E+00 | 0.0000E+00 | 0.0000E+00 |
| S3 | 6.1933E−06 | −3.8321E−06 | 0.0000E+00 | 0.0000E+00 | 0.0000E+00 | 0.0000E+00 | 0.0000E+00 |
| S4 | −1.2412E−06 | −4.5076E−06 | 0.0000E+00 | 0.0000E+00 | 0.0000E+00 | 0.0000E+00 | 0.0000E+00 |
| S5 | −1.5423E−05 | −7.4644E−06 | 1.9063E−07 | 6.6112E−06 | 8.3988E−06 | 6.8015E−06 | 2.8567E−06 |
| S6 | 4.5063E−05 | 5.1485E−06 | 1.8055E−07 | −3.8908E−06 | −1.4746E−07 | −7.9037E−07 | −5.9171E−07 |
| S7 | −6.4691E−04 | −2.5875E−04 | 6.5118E−05 | 1.1559E−05 | −7.0257E−05 | −3.9416E−05 | −5.2639E−06 |
| S8 | −4.7064E−04 | −3.5134E−04 | 1.8258E−05 | 4.1365E−05 | −6.5757E−06 | −2.2858E−05 | 5.6428E−06 |
| S9 | −1.8768E−03 | −2.3478E−03 | −8.2662E−04 | 9.3777E−05 | 2.6847E−04 | 1.6637E−04 | 7.3109E−05 |
| S10 | −2.2655E−03 | 7.2437E−04 | 1.3247E−03 | 6.1624E−05 | −2.2617E−04 | 6.6068E−05 | 1.2329E−04 |
| S11 | −8.6520E−03 | −4.0880E−03 | 1.2307E−03 | −9.4358E−05 | −1.5224E−03 | −4.1759E−04 | 2.0394E−04 |
| S12 | 4.3244E−03 | −5.6080E−03 | −7.8481E−04 | 1.3674E−04 | −1.0881E−03 | −8.3907E−05 | 9.4089E−04 |
| S13 | 1.7315E−02 | −1.5019E−02 | 1.0312E−02 | −5.8814E−03 | 1.9284E−03 | 4.4454E−04 | −2.6476E−04 |
| S14 | 2.1211E−02 | −1.1097E−02 | 1.2308E−02 | −9.6670E−03 | 2.6019E−03 | −1.4420E−03 | 3.9313E−03 |

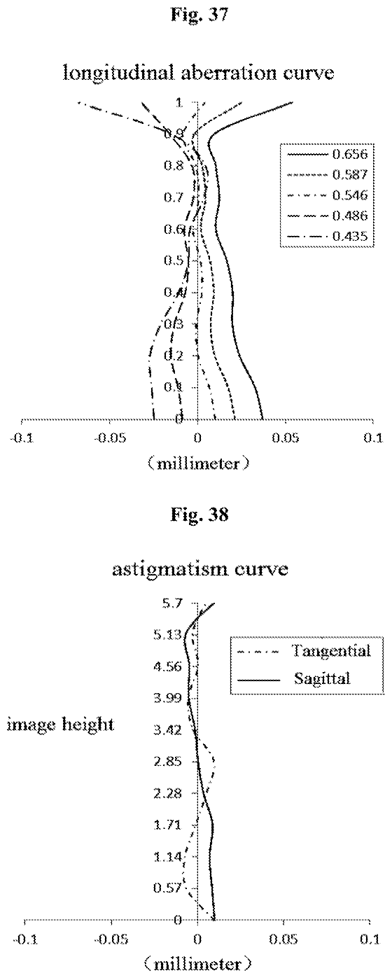

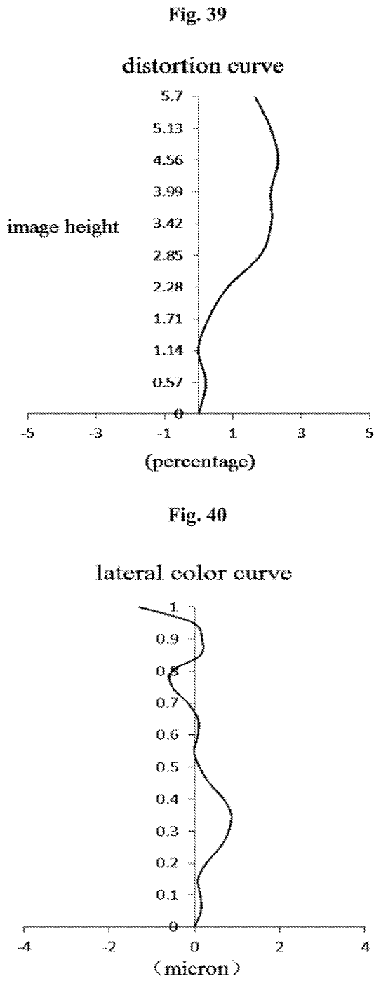

FIG. 37 shows a longitudinal aberration curve of the camera lens assembly of Example 8, which represents deviations of a convergence focal point after light with different wavelengths passes through the camera lens assembly. FIG. 38 shows an astigmatism curve of the camera lens assembly of Example 8, which represents a tangential image surface curvature and a sagittal image surface curvature. FIG. 39 shows a distortion curve of the camera lens assembly of Example 8, which represents distortion values corresponding to different fields of view. FIG. 40 shows a lateral color curve of the camera lens assembly of Example 8, which represents deviations of different image heights on the imaging surface after the light passes through the camera lens assembly.

According to FIGS. 37-40, it can be seen that the camera lens assembly provided in Example 8 may achieve good imaging quality.

### EXAMPLE 9

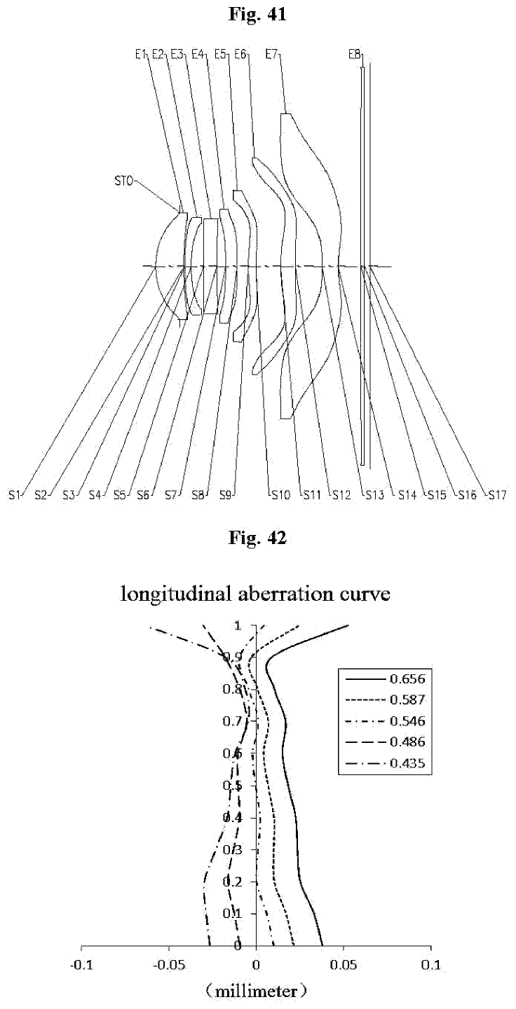

As shown in FIGS. 41-45, the camera lens assembly in Example 9 of the disclosure is described. In this example and the following examples, for the sake of brevity, some descriptions similar to Example 1 will be omitted. FIG. 41 shows a structural schematic diagram of a camera lens assembly in Example 9.

As shown in FIG. 41, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a negative refractive power, an object-side surface S7 of the fourth lens is a concave surface, and an image-side surface S8 of the fourth lens is a convex surface. The fifth lens E5 has a positive refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.10 mm, a maximum field of view FOV of the camera lens assembly is 84.9°, ImgH is a half of a diagonal length of an effective pixel region on the imaging surface S17, and ImgH is 5.72 mm.

Table 17 shows a basic structure parameter table of the camera lens assembly of Example 9, wherein the units of curvature radius, thickness/distance and focal length are all millimeters (mm).

TABLE 17

| | | | | Material | | Conic |
|---|---|---|---|---|---|---|
| Surface | Surface | Curvature | Thick- | Refractive | Abbe | coeffi- |
| number | type | radius | ness | index | number | cient |
| OBJ | Spherical | Infinity | Infinity | | | |
| STO | Spherical | Infinity | −0.7558 | | | |
| S1 | Aspheric | 2.1117 | 0.8786 | 1.536 | 55.60 | 0.0000 |
| S2 | Aspheric | 8.9015 | 0.0316 | | | 0.0000 |
| S3 | Aspheric | 6.9542 | 0.2000 | 1.677 | 19.20 | 0.0000 |
| S4 | Aspheric | 3.7858 | 0.3826 | | | 0.0000 |
| S5 | Aspheric | 15.1827 | 0.4176 | 1.677 | 19.20 | 0.0000 |
| S6 | Aspheric | 15.5571 | 0.2772 | | | 0.0000 |
| S7 | Aspheric | −19.3034 | 0.3591 | 1.536 | 55.60 | 0.0000 |
| S8 | Aspheric | −43.4638 | 0.3444 | | | 0.0000 |
| S9 | Aspheric | 3.8264 | 0.2443 | 1.590 | 32.48 | 0.0000 |
| S10 | Aspheric | 4.9042 | 0.7690 | | | 0.0000 |
| S11 | Aspheric | 4.7679 | 0.4634 | 1.540 | 52.36 | 0.0000 |
| S12 | Aspheric | 57.6324 | 0.8356 | | | 0.0000 |
| S13 | Aspheric | −20.6136 | 0.5000 | 1.537 | 55.63 | 0.0000 |
| S14 | Aspheric | 2.4206 | 0.7152 | | | −1.0000 |
| S15 | Spherical | Infinity | 0.1100 | 1.519 | 64.17 | |
| S16 | Spherical | Infinity | 0.1713 | | | |
| S17 | Spherical | Infinity | | | | |

Table 18 shows high-order term coefficients that can be used for each aspheric mirror surface in Example 9, wherein a surface type of each aspheric surface may be defined by the formula (1) provided in Example 1 above.

TABLE 18

| Surface number | A4 | A6 | A8 | A10 | A12 | A14 | A16 |
|---|---|---|---|---|---|---|---|
| S1 | 1.0485E−02 | −4.5082E−03 | −3.9123E−03 | −1.6767E−03 | −5.8723E−04 | −1.3388E−04 | −2.5548E−05 |
| S2 | −2.0061E−02 | 3.9892E−03 | −3.7683E−03 | 7.2269E−04 | −4.0888E−04 | 1.0002E−04 | −5.2141E−05 |
| S3 | 3.8309E−02 | 2.4792E−02 | 1.2333E−03 | 1.9570E−03 | −1.1502E−04 | 1.4021E−04 | −3.7167E−05 |
| S4 | 5.7998E−02 | 1.7409E−02 | 3.2894E−03 | 1.2769E−03 | 2.3468E−04 | 9.1053E−05 | 6.6903E−06 |
| S5 | −5.7629E−02 | 4.2859E−04 | 7.3135E−04 | 1.7690E−05 | −7.4737E−05 | −3.1990E−05 | −3.4037E−06 |
| S6 | −4.2422E−02 | 1.5235E−02 | 5.3874E−03 | 4.7009E−04 | −3.7486E−04 | −1.0492E−04 | 2.6465E−05 |
| S7 | −1.6134E−01 | 7.3074E−02 | 9.4836E−03 | −1.3659E−02 | −3.4722E−03 | 3.1186E−03 | 1.2322E−03 |
| S8 | −3.8913E−01 | 1.0338E−01 | 1.1981E−02 | −1.5956E−02 | −8.5610E−03 | 2.4949E−03 | 2.1308E−03 |
| S9 | −1.1773E+00 | 2.6520E−02 | 8.3315E−03 | 1.5300E−02 | 3.3691E−03 | 6.7744E−03 | 2.2872E−03 |
| S10 | −1.2752E+00 | 1.9388E−01 | −1.1259E−02 | −1.2249E−02 | −2.3457E−03 | 8.8866E−03 | 1.5088E−04 |
| S11 | −2.7135E+00 | 4.0211E−01 | 1.4378E−01 | −1.0932E−01 | 5.0543E−03 | 1.8407E−02 | 8.6407E−04 |
| S12 | −1.6034E+00 | 1.1224E−01 | 7.1727E−02 | −5.1668E−02 | 6.8181E−02 | 7.0989E−03 | −5.6301E−03 |
| S13 | −1.5169E+00 | 1.1871E+00 | −7.2235E−01 | 3.7994E−01 | −1.6200E−01 | 4.0911E−02 | −2.4677E−03 |
| S14 | −8.1208E+00 | 2.1301E+00 | −7.0925E−01 | 2.4303E−01 | −1.8741E−01 | 8.3596E−02 | −4.9102E−02 |
| Surface number | A18 | A20 | A22 | A24 | A26 | A28 | A30 |
| S1 | 4.2154E−06 | −4.1367E−06 | 0.0000E+00 | 0.0000E+00 | 0.0000E+00 | 0.0000E+00 | 0.0000E+00 |
| S2 | 1.9167E−05 | −7.0541E−06 | −8.2316E−09 | 0.0000E+00 | 0.0000E+00 | 0.0000E+00 | 0.0000E+00 |
| S3 | 1.5440E−05 | −2.7211E−06 | 0.0000E+00 | 0.0000E+00 | 0.0000E+00 | 0.0000E+00 | 0.0000E+00 |
| S4 | 5.5647E−06 | 2.2172E−06 | 0.0000E+00 | 0.0000E+00 | 0.0000E+00 | 0.0000E+00 | 0.0000E+00 |
| S5 | −7.5961E−06 | −7.5299E−06 | −5.9045E−06 | −2.5030E−06 | 9.0140E−07 | 3.5959E−06 | 2.5059E−06 |
| S6 | 5.0260E−05 | 1.4619E−05 | 2.8687E−07 | −8.3166E−06 | −6.3612E−06 | −5.0928E−06 | −1.2984E−06 |
| S7 | −8.7075E−04 | −6.8594E−04 | −4.4347E−06 | 1.7066E−04 | −7.0749E−06 | −7.1157E−05 | −4.8481E−05 |
| S8 | 1.3444E−04 | −7.1199E−04 | −4.9603E−04 | −1.2487E−04 | 7.4277E−05 | 9.8966E−05 | 4.4612E−05 |
| S9 | −2.1169E−03 | −2.6488E−03 | −9.2684E−04 | 1.3881E−04 | 3.8981E−04 | 2.1522E−04 | 1.1357E−04 |
| S10 | −2.2913E−03 | 8.0561E−04 | 1.4530E−03 | 3.0622E−05 | −2.5480E−04 | 7.8763E−05 | 2.0260E−04 |
| S11 | −6.5571E−03 | 2.6730E−04 | 2.1886E−03 | −4.9784E−04 | −7.5650E−04 | 1.6991E−04 | 1.4308E−04 |
| S12 | −1.9161E−03 | −6.9821E−04 | −8.2733E−04 | −1.5779E−03 | −8.9194E−04 | 1.0278E−04 | −1.5166E−05 |
| S13 | −2.6697E−04 | −3.4453E−03 | 5.6211E−03 | −4.7032E−03 | 2.2859E−03 | −6.7230E−04 | 8.2911E−05 |
| S14 | 1.1139E−02 | −2.8544E−03 | 8.0593E−03 | −8.7235E−03 | 2.1111E−03 | −8.4920E−04 | 2.7055E−03 |

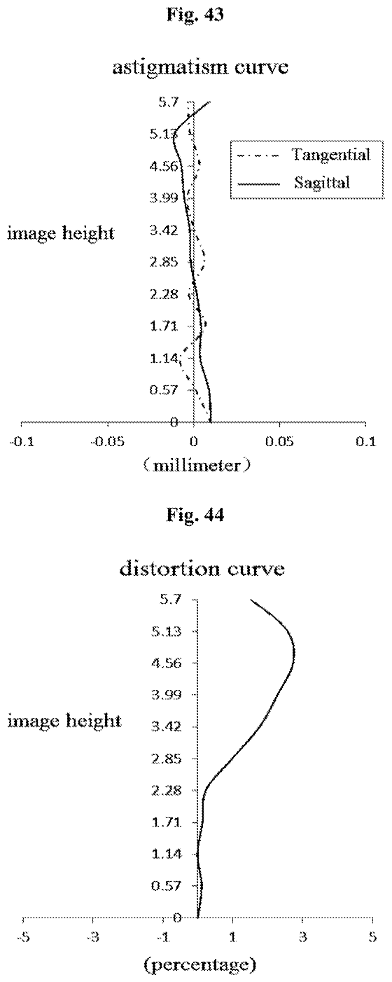

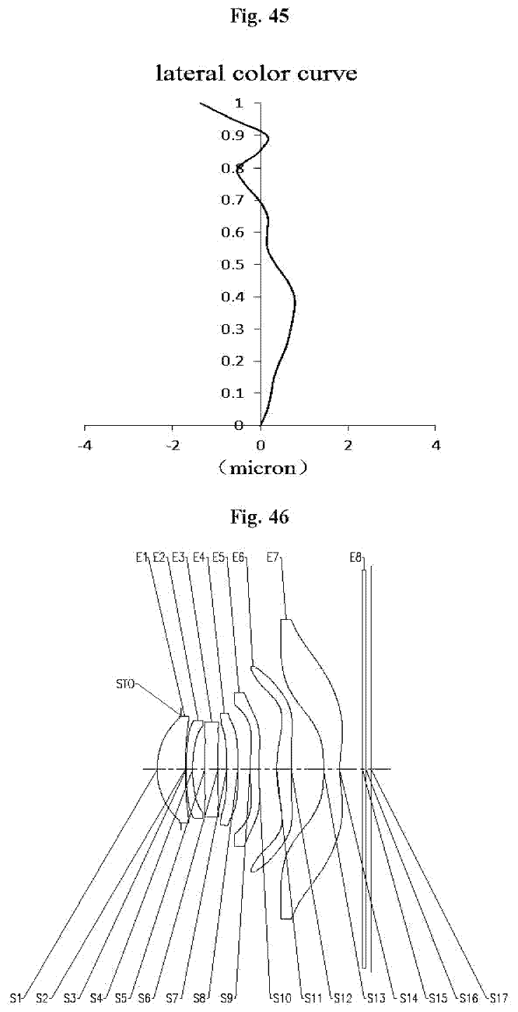

FIG. 42 shows a longitudinal aberration curve of the camera lens assembly of Example 9, which represents deviations of a convergence focal point after light with different wavelengths passes through the camera lens assembly. FIG. 43 shows an astigmatism curve of the camera lens assembly of Example 9, which represents a tangential image surface curvature and a sagittal image surface curvature. FIG. 44 shows a distortion curve of the camera lens assembly of Example 9, which represents distortion values corresponding to different fields of view. FIG. 45 shows a lateral color curve of the camera lens assembly of Example 9, which represents deviations of different image heights on the imaging surface after the light passes through the camera lens assembly.

According to FIGS. 42-45, it can be seen that the camera lens assembly provided in Example 9 may achieve good imaging quality.

### EXAMPLE 10

As shown in FIGS. 46-50, the camera lens assembly in Example 10 of the disclosure is described. In this example and the following examples, for the sake of brevity, some descriptions similar to Example 1 will be omitted. FIG. 46 shows a structural schematic diagram of a camera lens assembly in Example 10.

As shown in FIG. 46, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a negative refractive power, an object-side surface S7 of the fourth lens is a concave surface, and an image-side surface S8 of the fourth lens is a convex surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.10 mm, a maximum field of view FOV of the camera lens assembly is 84.9°, ImgH is a half of a diagonal length of an effective pixel region on the imaging surface S17, and ImgH is 5.72 mm.

Table 19 shows a basic structure parameter table of the camera lens assembly of Example 10, wherein the units of curvature radius, thickness/distance and focal length are all millimeters (mm).

TABLE 19

| | | | | Material | | Conic |
|---|---|---|---|---|---|---|
| Surface | Surface | Curvature | Thick- | Refractive | Abbe | coeffi- |
| number | type | radius | ness | index | number | cient |
| OBJ | Spherical | Infinity | Infinity | | | |
| STO | Spherical | Infinity | −0.7565 | | | |
| S1 | Aspheric | 2.1081 | 0.8798 | 1.536 | 55.60 | 0.0000 |
| S2 | Aspheric | 9.0312 | 0.0323 | | | 0.0000 |
| S3 | Aspheric | 7.0976 | 0.2000 | 1.677 | 19.20 | 0.0000 |
| S4 | Aspheric | 3.8282 | 0.3813 | | | 0.0000 |
| S5 | Aspheric | 18.0267 | 0.4106 | 1.677 | 19.20 | 0.0000 |
| S6 | Aspheric | 19.2097 | 0.2741 | | | 0.0000 |
| S7 | Aspheric | −22.0112 | 0.3523 | 1.536 | 55.60 | 0.0000 |
| S8 | Aspheric | −33.6652 | 0.3792 | | | 0.0000 |
| S9 | Aspheric | 4.1753 | 0.2647 | 1.591 | 32.14 | 0.0000 |
| S10 | Aspheric | 4.0318 | 0.5709 | | | 0.0000 |
| S11 | Aspheric | 3.9687 | 0.4554 | 1.545 | 49.20 | 0.0000 |
| S12 | Aspheric | 55.0284 | 1.0069 | | | 0.0000 |
| S13 | Aspheric | −24.7534 | 0.5000 | 1.536 | 55.60 | 0.0000 |
| S14 | Aspheric | 2.4396 | 0.7132 | | | −1.0000 |
| S15 | Spherical | Infinity | 0.1100 | 1.519 | 64.17 | |
| S16 | Spherical | Infinity | 0.1692 | | | |
| S17 | Spherical | Infinity | | | | |

Table 20 shows high-order term coefficients that can be used for each aspheric mirror surface in Example 10, wherein a surface type of each aspheric surface may be defined by the formula (1) provided in Example 1 above.

TABLE 20

| Surface number | A4 | A6 | A8 | A10 | A12 | A14 | A16 |
|---|---|---|---|---|---|---|---|
| S1 | 9.8244E−03 | −4.6796E−03 | −3.9596E−03 | −1.6780E−03 | −5.8296E−04 | −1.2702E−04 | −2.1998E−05 |
| S2 | −1.8504E−02 | 3.7620E−03 | −3.7370E−03 | 7.3387E−04 | −3.8920E−04 | 9.8478E−05 | −4.8665E−05 |
| S3 | 4.1068E−02 | 2.3963E−02 | 1.2682E−03 | 1.9597E−03 | −7.7595E−05 | 1.4720E−04 | −2.8472E−05 |
| S4 | 6.1259E−02 | 1.7435E−02 | 3.3305E−03 | 1.2825E−03 | 2.2239E−04 | 8.0823E−05 | −1.5350E−06 |
| S5 | −3.9890E−02 | −7.1856E−05 | 3.4732E−04 | 4.7955E−05 | −5.9723E−06 | −1.3231E−05 | −8.2041E−07 |
| S6 | −4.0892E−02 | 1.5657E−02 | 5.4400E−03 | 4.4670E−04 | −3.8026E−04 | −1.4296E−04 | 7.4080E−06 |
| S7 | −1.8598E−01 | 7.6872E−02 | 1.2357E−02 | −1.5318E−02 | −4.2589E−03 | 3.5270E−03 | 1.6464E−03 |
| S8 | −4.1870E−01 | 1.0004E−01 | 1.9461E−02 | −1.8244E−02 | −1.1028E−02 | 2.8902E−03 | 3.4083E−03 |
| S9 | −1.1599E+00 | 5.0330E−02 | −2.3935E−03 | 1.8952E−02 | 2.8342E−03 | 6.9821E−03 | 1.8294E−03 |
| S10 | −1.5097E+00 | 2.8229E−01 | −4.0449E−02 | −3.1548E−03 | −4.1035E−03 | 9.5811E−03 | −1.2329E−03 |
| S11 | −3.0543E+00 | 4.0754E−01 | 1.2271E−01 | −1.0620E−01 | −6.1866E−03 | 2.8683E−02 | −3.3295E−05 |
| S12 | −1.6574E+00 | −1.9256E−02 | 1.0334E−01 | −3.9807E−02 | 5.0107E−02 | 2.3146E−02 | −6.8367E−03 |
| S13 | −1.6656E+00 | 1.2346E+00 | −7.2525E−01 | 3.6852E−01 | −1.5483E−01 | 4.1246E−02 | −8.0206E−03 |
| S14 | −8.1868E+00 | 2.1745E+00 | −7.2659E−01 | 2.4036E−01 | −1.8028E−01 | 6.7741E−02 | −4.7461E−02 |
| Surface number | A18 | A20 | A22 | A24 | A26 | A28 | A30 |
| S1 | 6.0217E−06 | −2.6249E−06 | 0.0000E+00 | 0.0000E+00 | 0.0000E+00 | 0.0000E+00 | 0.0000E+00 |
| S2 | 1.7253E−05 | −6.3111E−06 | −2.9272E−07 | 0.0000E+00 | 0.0000E+00 | 0.0000E+00 | 0.0000E+00 |
| S3 | 1.7352E−05 | 3.2003E−07 | 0.0000E+00 | 0.0000E+00 | 0.0000E+00 | 0.0000E+00 | 0.0000E+00 |
| S4 | −5.0028E−07 | −3.6484E−07 | 0.0000E+00 | 0.0000E+00 | 0.0000E+00 | 0.0000E+00 | 0.0000E+00 |
| S5 | −2.8073E−06 | −4.1810E−07 | 6.2419E−07 | 1.9257E−06 | −2.8253E−07 | −6.5764E−07 | 1.8330E−07 |
| S6 | 4.3847E−05 | 2.0493E−05 | 5.4794E−06 | −3.2561E−06 | −3.8231E−06 | −4.3400E−06 | −1.6483E−06 |
| S7 | −9.2981E−04 | −9.3924E−04 | −1.0354E−04 | 2.1443E−04 | 6.6806E−05 | −3.9202E−05 | −4.3899E−05 |
| S8 | 7.0502E−04 | −1.1058E−03 | −9.9980E−04 | −3.3054E−04 | 1.6180E−04 | 2.2496E−04 | 9.9043E−05 |
| S9 | −1.8389E−03 | −2.4454E−03 | −9.2146E−04 | 3.6207E−05 | 3.3997E−04 | 2.1443E−04 | 9.3294E−05 |
| S10 | −1.7172E−03 | 9.0523E−04 | 1.2428E−03 | −1.2933E−04 | −1.5230E−04 | 1.2572E−04 | 1.6347E−04 |
| S11 | −7.8289E−03 | 1.1982E−03 | 2.0614E−03 | −1.2906E−03 | −4.1668E−04 | 4.1760E−04 | 8.9700E−05 |
| S12 | −5.0465E−03 | 1.5968E−03 | 1.9541E−04 | −3.1203E−03 | −1.4140E−03 | 5.3563E−05 | −1.1995E−04 |
| S13 | 7.1588E−03 | −8.8519E−03 | 7.5854E−03 | −4.8950E−03 | 1.7786E−03 | −3.6897E−04 | −9.6041E−05 |
| S14 | 1.6133E−02 | −1.1649E−02 | 8.8272E−03 | −8.3122E−03 | 1.3799E−03 | 6.4792E−04 | 3.3006E−03 |

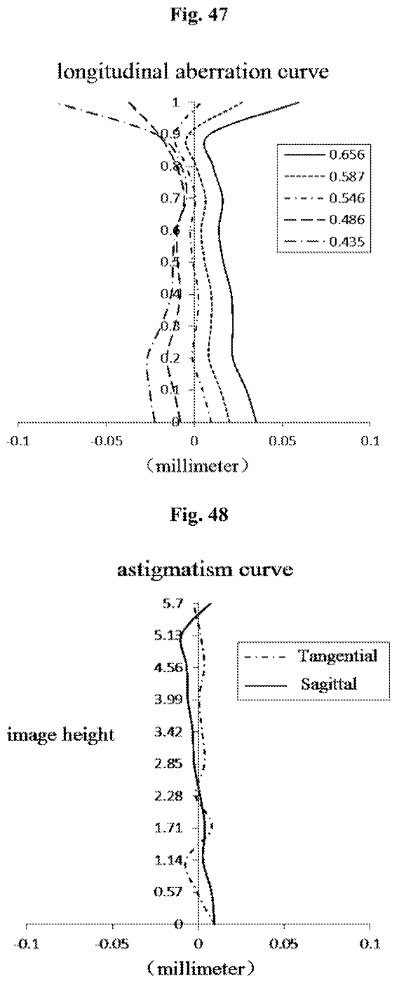

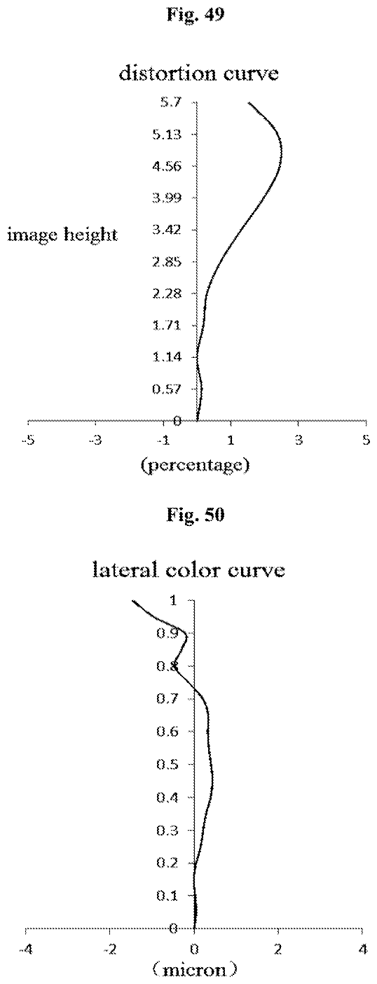

FIG. 47 shows a longitudinal aberration curve of the camera lens assembly of Example 10, which represents deviations of a convergence focal point after light with different wavelengths passes through the camera lens assembly. FIG. 48 shows an astigmatism curve of the camera lens assembly of Example 10, which represents a tangential image surface curvature and a sagittal image surface curvature. FIG. 49 shows a distortion curve of the camera lens assembly of Example 10, which represents distortion values corresponding to different fields of view. FIG. 50 shows a lateral color curve of the camera lens assembly of Example 10, which represents deviations of different image heights on the imaging surface after the light passes through the camera lens assembly.

According to FIGS. 47-50, it can be seen that the camera lens assembly provided in Example 10 may achieve good imaging quality.

### EXAMPLE 11

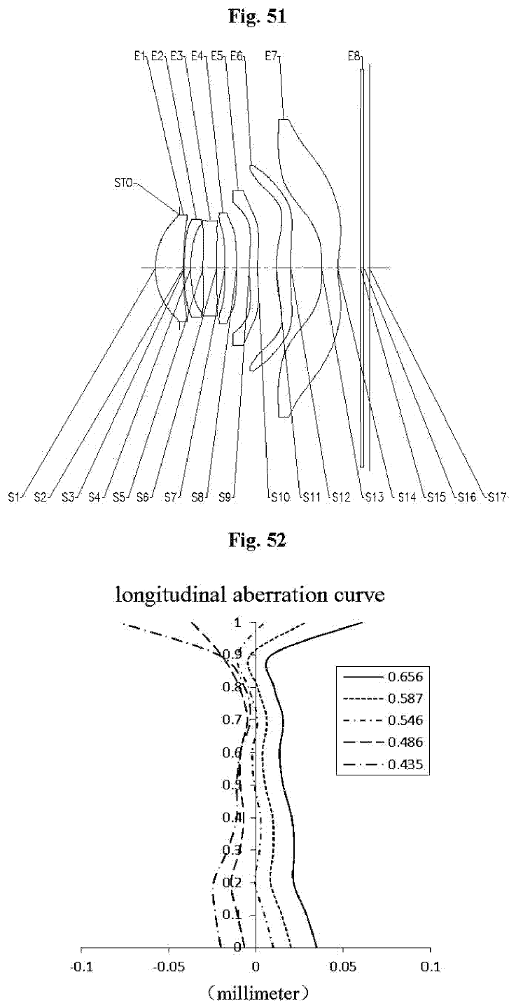

As shown in FIGS. 51-55, the camera lens assembly in Example 11 of the disclosure is described. In this example and the following examples, for the sake of brevity, some descriptions similar to Example 1 will be omitted. FIG. 51 shows a structural schematic diagram of a camera lens assembly in Example 11.

As shown in FIG. 51, the camera lens assembly sequentially includes from an object side to an image side: a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 of the first lens is a convex surface, and an image-side surface S2 of the first lens is a concave surface. The second lens E2 has a negative refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a concave surface, and an image-side surface S8 of the fourth lens is a convex surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a concave surface. Light from an object sequentially passes through the surfaces S1 to S16 and is finally imaged on the imaging surface S17.

In this example, a total effective focal length f of the camera lens assembly is 6.10 mm, a maximum field of view FOV of the camera lens assembly is 84.9°, ImgH is a half of a diagonal length of an effective pixel region on the imaging surface S17, and ImgH is 5.73 mm.

Table 21 shows a basic structure parameter table of the camera lens assembly of Example 11, wherein the units of curvature radius, thickness/distance and focal length are all millimeters (mm).

TABLE 21

| | | | | Material | | Conic |
|---|---|---|---|---|---|---|
| Surface | Surface | Curvature | Thick- | Refractive | Abbe | coeffi |
| number | type | radius | ness | index | number | -cient |
| OBJ | Spherical | Infinity | Infinity | | | |
| STO | Spherical | Infinity | −0.7562 | | | |
| S1 | Aspheric | 2.1091 | 0.8793 | 1.536 | 55.60 | 0.0000 |
| S2 | Aspheric | 9.0996 | 0.0310 | | | 0.0000 |
| S3 | Aspheric | 7.1690 | 0.2000 | 1.677 | 19.20 | 0.0000 |
| S4 | Aspheric | 3.8478 | 0.3818 | | | 0.0000 |
| S5 | Aspheric | 18.0251 | 0.4293 | 1.677 | 19.20 | 0.0000 |
| S6 | Aspheric | 18.1918 | 0.2605 | | | 0.0000 |
| S7 | Aspheric | −21.6310 | 0.3617 | 1.539 | 53.18 | 0.0000 |
| S8 | Aspheric | −20.9214 | 0.3982 | | | 0.0000 |
| S9 | Aspheric | 4.5678 | 0.2579 | 1.593 | 31.63 | 0.0000 |
| S10 | Aspheric | 4.4374 | 0.5922 | | | 0.0000 |
| S11 | Aspheric | 4.2524 | 0.4495 | 1.553 | 48.53 | 0.0000 |
| S12 | Aspheric | 57.7421 | 0.9641 | | | 0.0000 |
| S13 | Aspheric | −25.1763 | 0.5000 | 1.536 | 55.60 | 0.0000 |
| S14 | Aspheric | 2.4018 | 0.7142 | | | −1.0000 |
| S15 | Spherical | Infinity | 0.1100 | 1.519 | 64.17 | |
| S16 | Spherical | Infinity | 0.1703 | | | |
| S17 | Spherical | Infinity | | | | |

Table 22 shows high-order term coefficients that can be used for each aspheric mirror surface in Example 11, wherein a surface type of each aspheric surface may be defined by the formula (1) provided in Example 1 above.

TABLE 22

| Surface number | A4 | A6 | A8 | A10 | A12 | A14 | A16 |
|---|---|---|---|---|---|---|---|
| S1 | 9.7150E−03 | −4.6977E−03 | −3.9680E−03 | −1.6749E−03 | −5.7747E−04 | −1.2176E−04 | −2.0037E−05 |
| S2 | −1.7365E−02 | 3.7865E−03 | −3.8306E−03 | 7.9803E−04 | −4.2035E−04 | 1.0988E−04 | −5.5030E−05 |
| S3 | 4.2829E−02 | 2.3996E−02 | 1.1919E−03 | 1.9965E−03 | −1.0673E−04 | 1.5166E−04 | −3.5083E−05 |
| S4 | 6.1400E−02 | 1.7398E−02 | 3.3016E−03 | 1.2835E−03 | 2.2004E−04 | 8.2263E−05 | −2.3069E−06 |
| S5 | −3.9158E−02 | −8.9333E−05 | 3.0639E−04 | 4.8057E−05 | 5.4110E−07 | −1.0653E−05 | −1.3143E−07 |
| S6 | −4.4673E−02 | 1.5400E−02 | 5.6684E−03 | 5.4504E−04 | −4.0011E−04 | −1.8144E−04 | −1.6078E−05 |
| S7 | −1.8001E−01 | 7.5318E−02 | 1.3768E−02 | −1.5816E−02 | −4.6076E−03 | 3.7224E−03 | 1.9730E−03 |
| S8 | −3.8922E−01 | 9.5517E−02 | 2.1741E−02 | −1.9401E−02 | −1.1021E−02 | 2.7221E−03 | 3.7612E−03 |
| S9 | −1.1075E+00 | 3.6624E−02 | 3.7123E−03 | 1.6234E−02 | 3.7350E−03 | 6.7305E−03 | 2.2088E−03 |
| S10 | −1.4089E+00 | 2.6545E−01 | −3.0955E−02 | −8.0662E−03 | −1.9359E−03 | 9.0026E−03 | −1.1103E−03 |
| S11 | −2.9124E+00 | 3.9176E−01 | 1.4857E−01 | −1.1573E−01 | −4.9202E−03 | 2.8732E−02 | 1.2575E−03 |
| S12 | −1.7232E+00 | −3.3128E−02 | 1.0772E−01 | −4.9977E−02 | 5.7329E−02 | 2.4285E−02 | −6.7364E−03 |
| S13 | −1.7062E+00 | 1.2466E+00 | −7.2945E−01 | 3.6756E−01 | −1.5277E−01 | 3.9304E−02 | −5.9826E−03 |
| S14 | −8.2912E+00 | 2.1809E+00 | −7.2591E−01 | 2.3949E−01 | −1.8718E−01 | 7.2058E−02 | −4.6115E−02 |
| Surface number | A18 | A20 | A22 | A24 | A26 | A28 | A30 |
| S1 | 6.6596E−06 | −3.1280E−06 | 0.0000E+00 | 0.0000E+00 | 0.0000E+00 | 0.0000E+00 | 0.0000E+00 |
| S2 | 1.9140E−05 | −7.0400E−06 | −1.9052E−07 | 0.0000E+00 | 0.0000E+00 | 0.0000E+00 | 0.0000E+00 |
| S3 | 1.7895E−05 | −2.5098E−07 | 0.0000E+00 | 0.0000E+00 | 0.0000E+00 | 0.0000E+00 | 0.0000E+00 |
| S4 | −1.0008E−06 | −7.4070E−07 | 0.0000E+00 | 0.0000E+00 | 0.0000E+00 | 0.0000E+00 | 0.0000E+00 |
| S5 | −2.9581E−06 | −1.2694E−06 | 3.7594E−07 | 1.8726E−06 | −8.4656E−08 | −5.9644E−07 | 1.4563E−07 |
| S6 | 4.0518E−05 | 2.1043E−05 | 8.1017E−06 | −2.4837E−06 | −3.1850E−06 | −4.6618E−06 | −1.3967E−06 |
| S7 | −9.8636E−04 | −1.1431E−03 | −2.0787E−04 | 2.4832E−04 | 1.2257E−04 | −1.8023E−05 | −4.4659E−05 |
| S8 | 7.6779E−04 | −1.1120E−03 | −1.1006E−03 | −3.5410E−04 | 1.6108E−04 | 2.4160E−04 | 9.6194E−05 |
| S9 | −1.9178E−03 | −2.4147E−03 | −9.7974E−04 | 1.9754E−05 | 3.2126E−04 | 2.1756E−04 | 9.0532E−05 |
| S10 | −2.0119E−03 | 1.1228E−03 | 1.1819E−03 | −1.5598E−04 | −1.5931E−04 | 1.5042E−04 | 1.5709E−04 |
| S11 | −8.7952E−03 | 1.1175E−03 | 2.2124E−03 | −1.3364E−03 | −4.2499E−04 | 5.2786E−04 | 6.8088E−05 |
| S12 | −5.9372E−03 | 1.9505E−03 | 3.2684E−04 | −3.4562E−03 | −1.5391E−03 | 1.4796E−04 | −1.7157E−04 |
| S13 | 6.0737E−03 | −8.6732E−03 | 7.5889E−03 | −4.8133E−03 | 1.5814E−03 | −2.7233E−04 | −1.4377E−04 |
| S14 | 1.3722E−02 | −1.2363E−02 | 7.8951E−03 | −8.4487E−03 | 1.4540E−03 | 6.5465E−04 | 3.4370E−03 |

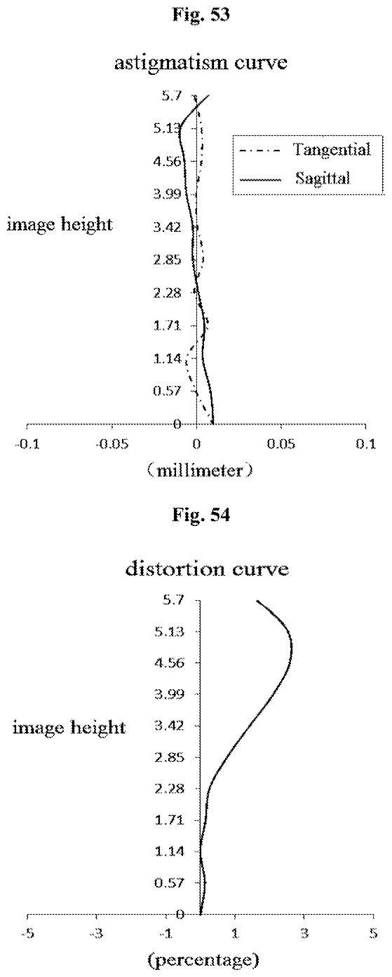

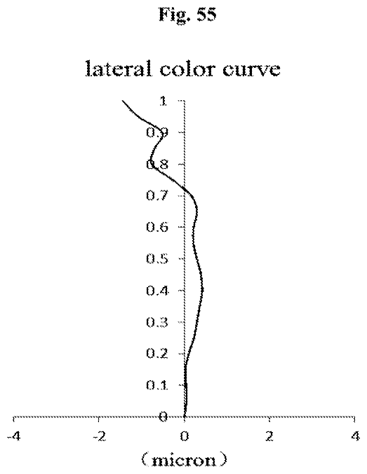

FIG. 52 shows a longitudinal aberration curve of the camera lens assembly of Example 11, which represents deviations of a convergence focal point after light with different wavelengths passes through the camera lens assembly. FIG. 53 shows an astigmatism curve of the camera lens assembly of Example 11, which represents a tangential image surface curvature and a sagittal image surface curvature. FIG. 54 shows a distortion curve of the camera lens assembly of Example 11, which represents distortion values corresponding to different fields of view. FIG. 55 shows a lateral color curve of the camera lens assembly of Example 11, which represents deviations of different image heights on the imaging surface after the light passes through the camera lens assembly.

According to FIGS. 52-55, it can be seen that the camera lens assembly provided in Example 11 may achieve good imaging quality.

To sum up, Example 1 to Example 11 respectively satisfy the relationships shown in Table 23.

TABLE 23

| Conditional expression/Example | 1 | 2 | 3 | 4 | 5 | 6 |
|---|---|---|---|---|---|---|
| TTL*(lmgH/f) | 6.35 | 6.39 | 6.36 | 6.24 | 6.35 | 6.70 |
| f*tan(HFOV) | 5.50 | 5.50 | 5.55 | 5.46 | 5.45 | 5.98 |
| (CT4 + CT5)/T56 | 1.23 | 1.19 | 0.68 | 0.98 | 1.01 | 0.98 |
| (T23 + T45)/T34 | 3.46 | 3.46 | 3.80 | 3.42 | 3.81 | 1.96 |
| f/R9 | 0.41 | 0.75 | 1.66 | 1.95 | 0.71 | 0.08 |
| f(CT6 + T67 + CT7) | 4.01 | 4.17 | 3.95 | 3.29 | 4.36 | 3.06 |
| \|R1 − R2\|/CT1 | 5.22 | 5.42 | 8.02 | 6.60 | 3.94 | 7.24 |
| 2*DT11/(DT61 + DT72) | 0.39 | 0.39 | 0.39 | 0.41 | 0.40 | 0.43 |
| ET1/(CT1 − SAG11) | 1.52 | 1.57 | 1.91 | 1.95 | 1.62 | 1.84 |
| f67/(R11 + R14) | −0.78 | −0.87 | −0.77 | −2.49 | −0.96 | −0.92 |
| SAG22/ET2 | 1.29 | 1.28 | 1.03 | 1.11 | 1.29 | 1.00 |
| \|f/f3 + f/f4\| | 0.05 | 0.03 | 0.10 | 0.06 | 0.01 | 0.11 |
| f/f5 | 0.29 | 0.33 | 0.33 | −0.01 | 0.28 | 0.01 |
| (f2 + f7)/f1 | −3.51 | −3.58 | −3.50 | −3.50 | −4.40 | −3.27 |
| Conditional expression/Example | 7 | 8 | 9 | 10 | 11 | |
| TTL*(lmgH/f) | 6.41 | 6.29 | 6.29 | 6.29 | 6.29 | |
| f*tan(HFOV) | 5.45 | 5.58 | 5.58 | 5.58 | 5.58 | |
| (CT4 + CT5)/T56 | 0.73 | 0.62 | 0.78 | 1.08 | 1.05 | |
| (T23 + T45)/T34 | 3.24 | 3.07 | 2.62 | 2.77 | 2.99 | |
| f/R9 | 1.66 | 1.68 | 1.59 | 1.46 | 1.34 | |
| f/(CT6 + T67 + CT7) | 4.03 | 4.21 | 3.39 | 3.11 | 3.19 | |
| \|R1 − R2\|/CT1 | 7.73 | 7.15 | 7.73 | 7.87 | 7.95 | |
| 2*DT11/(DT61 + DT72) | 0.41 | 0.42 | 0.42 | 0.43 | 0.43 | |
| ET1/(CT1 − SAG11) | 1.80 | 1.92 | 1.95 | 1.94 | 1.95 | |
| f67/(R11 + R14) | −1.57 | −1.44 | −1.29 | −2.40 | −1.91 | |
| SAG22/ET2 | 0.96 | 0.93 | 0.90 | 0.89 | 0.89 | |
| \|f/f3 + f/f4\| | 0.03 | 0.11 | 0.08 | 0.03 | 0.01 | |
| f/f5 | 0.25 | 0.36 | 0.23 | −0.01 | −0.01 | |
| (f2 + t7)/f1 | −4.41 | −4.13 | −3.34 | −3.38 | −3.37 | |

Table 24 provides the effective focal length f of the camera lens assembly, the effective focal lengths f1 to f7 of each lens and the maximum field of view FOV of Example 1 to Example 11.

TABLE 24

| Example | | | | | | |
|---|---|---|---|---|---|---|
| parameter | 1 | 2 | 3 | 4 | 5 | 6 |
| f1(mm) | 5.02 | 5.01 | 4.83 | 4.90 | 5.43 | 4.91 |
| f2(mm) | −13.88 | −14.15 | −13.03 | −12.91 | −20.00 | −12.14 |
| f3(mm) | 131.04 | 275.61 | −67.05 | −179.85 | −173.43 | 26.08 |
| f4(mm) | 723.57 | −112.84 | −488.20 | −241.00 | 231.44 | −50.85 |
| f5(mm) | 20.62 | 17.98 | 18.64 | −978.76 | 21.11 | 565.22 |
| f6(mm) | 10.37 | 9.37 | 11.84 | 7.12 | 9.68 | 8.67 |
| f7(mm) | −3.75 | −3.77 | −3.86 | −4.22 | −3.90 | −3.89 |
| f(mm) | 6.01 | 6.01 | 6.06 | 5.96 | 5.96 | 6.15 |
| FOV(°) | 84.9 | 84.9 | 84.9 | 84.9 | 84.9 | 88.4 |
| ImgH(mm) | 6.15 | 5.70 | 5.73 | 5.75 | 5.68 | 5.69 |
| Example | | | | | | |
| parameter | 7 | 8 | 9 | 10 | 11 | |
| f1(mm) | 4.82 | 4.94 | 4.92 | 4.89 | 4.89 | |
| f2(mm) | −13.00 | −13.70 | −12.45 | −12.44 | −12.42 | |
| f3(mm) | −84.67 | −106.98 | 633.34 | 374.33 | 1402.19 | |
| f4(mm) | 162.65 | −117.12 | −64.85 | −119.38 | 999.78 | |
| f5(mm) | 23.44 | 16.86 | 27.02 | −631.64 | −1000.00 | |
| f6(mm) | −500.00 | −501.02 | 9.55 | 7.79 | 8.23 | |
| f7(mm) | −8.25 | −6.68 | −3.99 | −4.10 | −4.05 | |
| f(mm) | 5.96 | 6.10 | 6.10 | 6.10 | 6.10 | |
| FOV(°) | 84.9 | 84.9 | 84.9 | 84.9 | 84.9 | |
| ImgH(mm) | 5.70 | 5.73 | 5.72 | 5.72 | 5.73 | |

The disclosure also provides an imaging apparatus, whose electronic photosensitive element may be a photosensitive coupling element (CCD) or a complementary metal oxide semiconductor element (CMOS). The imaging apparatus may be an independent imaging device such as a digital camera or an imaging module integrated on a mobile electronic device such as a mobile phone. The imaging apparatus is equipped with the camera lens assembly described above.

Apparently, the described embodiments are only some but not all of the embodiments of the disclosure. All other embodiments obtained by the ordinary skill person in the art based on the embodiments of the disclosure without creative efforts shall fall within the protection scope of the disclosure.

It should be noted that the term used here is only for describing specific embodiments, and is not intended to limit the exemplary embodiments according to the disclosure. As used here, unless the context clearly indicates otherwise, the singular form is also intended to comprise the plural form. In addition, it should be understood that when the terms “including” and/or “comprising” are used in this description, they indicate the presence of features, steps, operations, devices, components and/or combinations thereof.

It should be noted that the terms “first”, “second” and so on in the description and claims of the disclosure and the above drawings are used to distinguish similar objects, but not necessarily to describe a specific order or precedence order. It should be understood that the data thus used may be interchanged in appropriate circumstances, so that the embodiments of the disclosure described here may be implemented in an order other than those illustrated or described here.

What has been described above is only the preferred embodiment of the disclosure, and it is not intended to limit the disclosure. For those skilled in the art, the disclosure may be modified and changed in various ways. Any modification, equivalent replacement, improvement, etc. made within the spirit and principle of the disclosure should be included in the scope of protection of the disclosure.

What is claimed is:

1. A camera lens assembly, sequentially comprising from an object side to an image side along an optical axis:
a first lens with a positive refractive power;
a second lens with a negative refractive power;
a third lens;
a fourth lens;
a fifth lens, an object-side surface thereof is a convex surface;
a sixth lens;
a seventh lens with a negative refractive power;
wherein TTL is an on-axis distance from an object-side surface of the first lens to an imaging surface of the camera lens assembly, ImgH is a half of a diagonal length of an effective pixel region on the imaging surface, and TTL, ImgH and an effective focal length f of the camera lens assembly satisfy: 6 mm<TTL*(ImgH/f)<7 mm;
a center thickness CT4 of the fourth lens, a center thickness CT5 of the fifth lens and an air space T56 of the fifth lens to the sixth lens on the optical axis satisfy: 0.5<(CT4−CT5)/T56≤1.3.

2. The camera lens assembly according to claim 1, wherein the effective focal length f of the camera lens assembly and a maximum half field of view HFOV of the camera lens assembly satisfy: f*tan(HFOV)≥5.4 mm.

3. The camera lens assembly according to claim 1, wherein an air space T23 from the second lens to the third lens on the optical axis, an air space T34 from the third lens to the fourth lens on the optical axis and an air space T45 from the fourth lens to the fifth lens on the optical axis satisfy: 1.9≤(T23+T45)/T34<4.0.

4. The camera lens assembly according to claim 1, wherein the effective focal length f of the camera lens assembly and a curvature radius R9 of the object-side surface of the fifth lens satisfy: 0<f/R9≤2.0.

5. The camera lens assembly according to claim 1, wherein the effective focal length f of the camera lens assembly, a center thickness CT6 of the sixth lens, a center thickness CT7 of the seventh lens and an air space T67 from the sixth lens to the seventh lens on the optical axis satisfy: 3≤f/(CT6+T67+CT7)<4.5.

6. The camera lens assembly according to claim 1, wherein a curvature radius R1 of an object-side surface of the first lens, a curvature radius R2 of an image-side surface of the first lens and a center thickness CT1 of the first lens satisfy: 3.5<|R1−R2|/CT1<8.5.

7. The camera lens assembly according to claim 1, wherein a maximum effective radius DT11 of an object-side surface of the first lens, a maximum effective radius DT61 of an object-side surface of the sixth lens and a maximum effective radius DT72 of an image-side surface of the seventh lens satisfy: 0.3<2*DT11/(DT61+DT72)<0.5.

8. The camera lens assembly according to claim 1, wherein SAG11 is an on-axis distance from an intersection point of an object-side surface of the first lens and the optical axis to a maximum effective radius of the object-side surface of the first lens, SAG11, a center thickness CT1 of the first lens and an edge thickness ET1 of the first lens at the maximum effective radius satisfy: 1.5≤ET1/(CT1−SAG11)≤2.0.

9. The camera lens assembly according to claim 1, wherein a combined focal length f67 of the sixth lens and the seventh lens, a curvature radius R11 of an object-side surface of the sixth lens and a curvature radius R14 of an image-side surface of the seventh lens satisfy: −2.5f67/(R11+R14)<−0.5.

10. The camera lens assembly according to claim 1, wherein SAG22 is an on-axis distance from an intersection point of an image-side surface of the second lens and the optical axis to a maximum effective radius of the image-side surface of the second lens, SAG22 and an edge thickness ET2 of the second lens at the maximum effective radius satisfy: 0.8<SAG22/ET2≤1.3.

11. The camera lens assembly according to claim 1, wherein the effective focal length f of the camera lens assembly, an effective focal length f3 of the third lens and an effective focal length f4 of the fourth lens satisfy: |f/f3+f/f4|<0.2.

12. The camera lens assembly according to claim 1, wherein the effective focal length f of the camera lens assembly and an effective focal length f5 of the fifth lens satisfy: −0.1<f/f5<0.5.

13. The camera lens assembly according to claim 1, wherein an effective focal length f1 of the first lens, an effective focal length f2 of the second lens and an effective focal length f7 of the seventh lens satisfy: −4.5≤(f2+f7)/f1<−3.0.

14. The camera lens assembly according to claim 1, wherein a center thickness CT2 of the second lens, a center thickness CT3 of the third lens, the center thickness CT4 of the fourth lens and the center thickness CT5 of the fifth lens satisfy: 0.3 mm≤(CT2+CT3+CT4+CT5)/4≤0.35 mm.

15. A camera lens assembly, sequentially comprising from an object side to an image side along an optical axis:
a first lens with a positive refractive power;
a second lens with a negative refractive power;
a third lens;
a fourth lens;
a fifth lens, an object-side surface thereof is a convex surface;
a sixth lens;
a seventh lens with a negative refractive power;
wherein a maximum effective radius DT11 of an object-side surface of the first lens, a maximum effective radius DT61 of an object-side surface of the sixth lens and a maximum effective radius DT72 of an image-side surface of the seventh lens satisfy: 0.3<2*DT11/(DT61+DT72)<0.5;
TTL is an on-axis distance from the object-side surface of the first lens to an imaging surface of the camera lens assembly, ImgH is a half of a diagonal length of an effective pixel region on the imaging surface, TTL, ImgH and an effective focal length f of the camera lens assembly satisfy: 6 mm<TTL*(ImgH/f)<7 mm.
